(19) United States
(12) Patent Application Publication
(10) Pub. No.: US 2026/0094340 A1
(43) Pub. Date: Apr. 2, 2026

(54) SYNTHETIC TRAINING DATA FOR ENDPOINTING MODELS

(71) Applicant: FEI Company, Hillsboro, OR (US)

(72) Inventors: Jamie Dee Gravell, Brno (CZ); Tomáš Onderlicka, Brno (CZ); Matej Dolník, Brno (CZ); Zoltán Orémuš, Šlapanice (CZ); Jakub Strejcek, Brno (CZ); Antonio Mani, Bernareggio (IT); Maurice Peemen, Rijsbergen (NL); Maurits Diephuis, Assen (NL); Nathaniel Burley, Beaverton, OR (US); Lucas Winiarski, Portland, OR (US); John Flanagan, Beaverton, OR (US); Christopher John Hakala, Hillsboro, OR (US); Hayley Maren Johanesen, Portland, OR (US)

(21) Appl. No.: 19/059,797

(22) Filed: Feb. 21, 2025

Related U.S. Application Data
(60) Provisional application No. 63/701,475, filed on Sep. 30, 2024.

(51) Int. Cl. G06T 15/00; G06V 10/25

(52) U.S. Cl. CPC G06T 15/00; G06V 10/25

(57) ABSTRACT

A computer-implemented method for generating synthetic data describing a sample can comprise processing, by a system operatively coupled to a processor, sample information describing a set of original features of a sample, resulting in processed model input information, and generating, by an analytical model, synthetic image data, usable to generate a synthetic image, and describing at least a portion of the set of original features and based on the processed model input information. The computer-implemented method further can comprise generating, by the system, the synthetic image of a pseudo-sample, based on the synthetic image data, having at least one pseudo-feature that is different from and based on the set of original features.

### CROSS-REFERENCE TO RELATED APPLICATIONS

This application claims priority to and the benefit of U.S. Provisional Application No. 63/701,475, entitled “Synthetic Data for Semiconductor Metrology, Imaging, and Microanalysis,” which was filed on Sep. 30, 2024. The entirety of the aforementioned application is hereby incorporated herein by reference.

### BACKGROUND

Analytical models, such as machine learning model and/or artificial intelligence models, can be employed to control imaging systems, sample preparation systems, manufacturing and/or fabricating systems, and/or the like.

Preparation of samples for training such analytical models can be a monumental task involving manual and timely preparation of dozens, hundreds, or even thousands of samples representative of various aspects and/or parameters on which an analytical model is to be trained.

### Technical Field

Embodiments of the present disclosure are directed to charged particle microscope systems, as well as algorithms and methods for their operation. In particular, some embodiments are directed toward analytical models, such as machine learning models and/or artificial intelligence models, for augmented sample preparation.

### SUMMARY

The following presents a summary to provide a basic understanding of one or more example embodiments described herein. This summary is not intended to identify key or critical elements, and/or to delineate scope of particular embodiments or scope of claims. Its sole purpose is to present concepts in a simplified form as a prelude to the more detailed description that is presented later. In one or more example embodiments, systems, computer-implemented methods, apparatuses and/or computer program products described herein can provide systems and/or methods for generating synthetic samples and/or sample data for use in training an analytical model, and/or for use of such trained model for controlling imaging systems, sample preparation systems, manufacturing and/or fabricating systems, and/or the like.

In accordance with an embodiment, a charged particle beam system can comprise a source of charged particles, a machine-actuated sample holder, and control circuitry operatively coupled to a memory that stores computer executable components, and a processor that executes the computer executable components stored in the memory to cause the processor to perform operations comprising generating image data of a sample disposed in the sample holder, inputting a portion of the image data to an analytical model that is trained on a dataset of synthetic image data describing synthetic images corresponding to the image data of the sample, and generating, by the analytical model, control instructions configured to modulate an operation of the source of charged particles or the sample holder in response to being processed by the control circuity.

In accordance with another embodiment, a computer-implemented method for generating synthetic data describing a sample can comprise processing, by a system operatively coupled to a processor, sample information describing a set of original features of a sample, resulting in processed model input information, and generating, by an analytical model, synthetic image data, usable to generate a synthetic image, and describing at least a portion of the set of original features and based on the processed model input information.

In accordance with still another embodiment, a computer program product facilitates a process for facilitating imaging device end pointing, the computer program product comprising a computer readable storage medium having program instructions embodied therewith, the program instructions executable by a processor to cause the processor to process, by the processor, sample information describing a set of original features of a sample, resulting in processed model input information, and generate, by the processor, synthetic image data, usable to generate a synthetic image, and describing at least a portion of the set of original features and based on the processed model input information.

In accordance with another embodiment, a computer-implemented method includes receiving microscope image data, detecting a feature in the microscope image data, receiving feature template data describing a grouping of features including the feature, detecting the grouping in the microscope image data based at least in part on the feature template data, generating template information describing the grouping, and outputting the template information.

Detecting the feature in the microscope image data can include inputting at least a portion of the microscope image data to a model configured to detect the feature and generating, as an output of the model, coordinate information describing a location of the feature in the microscope image data. The location of the feature can correspond to a set of coordinates for a centroid of the feature. The model can include a convolutional neural network trained to input the portion of the microscope image data and to output the coordinate information. The feature can be a first feature, the model can be a first model, the portion can be a first portion, the coordinate information can be first coordinate information, and the location can be a first location. The microscope image data can include a second feature. The method can further include inputting at least a second portion of the microscope image data to a second model configured to detect the second feature and generating, as an output of the second model, second coordinate information describing a second location of the second feature in the microscope image data.

The feature template data can describe a sequence of multiple features including the first feature. Detecting the grouping can include convolving the feature template data with the coordinate information and detecting an instance of the grouping in the microscope image data based at least in part on the location of the feature relative to at least a subset of the multiple features in the sequence. Detecting the instance of the grouping can include determining a first rank of the first feature in the sequence and determining that the first rank of the first feature and a second rank of a second feature in the sequence match the feature template data.

The feature template data can include feature multiplicity information and feature order information. Detecting the grouping in the image data can include detecting an instance of the grouping having an inverse feature order. The feature can form at least part of a device in an integrated circuit. The microscope image data can include an image generated by a charged particle microscope. The microscope image data can further include coordinate metadata mapping a pixel of the image data to a position on a sample.

Outputting the template information can include sending the template information to a charged particle microscope, the charged particle microscope being configured to generate image data based at least in part on the template information. The template information can include a location of the grouping in the microscope image data. The location of the grouping can correspond to a vertex of a bounding box circumscribing the grouping.

In accordance with another embodiment, one or more non-transitory machine-readable media, storing instructions that, when executed by a machine, cause the machine to perform operations of the methods of the preceding aspect.

In accordance with another embodiment, a system includes an analytical instrument, configured to generate image data, and a computing device, operably coupled with the analytical instrument and configured to receive the image data from the analytical instrument. The computing device can be configured to include the media and/or to perform operations of the methods of the preceding aspects. The analytical instrument can be or include a charged particle microscope. The computing device can be an instrument PC, a client computing device, or one or more servers. The computing device can be configured to receive the image data from the analytical instrument via one or more networks.

Embodiments of the present disclosure also can comprise systems, components, and methods in accordance with the preceding aspects. The terms and expressions which have been employed are used as terms of description and not of limitation, and there is no intention in the use of such terms and expressions of excluding any equivalents of the features shown and described or portions thereof, but it is recognized that various modifications are possible within the scope of the claimed subject matter. Thus, it should be understood that although the present claimed subject matter has been specifically disclosed by embodiments and optional features, modification and variation of the concepts herein disclosed can be resorted to by those skilled in the art, and that such modifications and variations are considered to be within the scope of this disclosure as defined by the appended claims.

The one or more example embodiments described herein can be implemented within, in connection with and/or coupled to an imaging device, imaging system, scientific measurement device, and/or scientific measurement system.

The one or more example embodiments disclosed herein can be applied to generate synthetic sample data for training an analytical model, train the analytical model on the synthetic sample data, and/or employ the analytical model for sample preparation, sample imaging, and/or control of an imaging and/or scientific measurement device and/or system.

The one or more example embodiments described herein can generate synthetic sample data and/or train an analytical model without preparing, fabricating and/or obtaining dozens, hundreds, or even thousands of samples, as is the case in existing frameworks. This can save power, bandwidth, device/system use time, user entity time, cost, etc.

Further, using the one or more example embodiments described herein, sample variety can be provided that otherwise may not be available in existing frameworks using all real world samples. Likewise, using the one or more example embodiments described herein, imaging guidance instructions can be provided, based on synthetic image training and/or generation, for setups not able to be otherwise generated using existing frameworks, such as due to limitations of preparation bandwidth in existing frameworks, and/or due to use of a less-than-robust model again due to the same limitations.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings. Not all instances of an element are necessarily labeled to reduce clutter in the drawings where appropriate. The drawings are not necessarily to scale, emphasis instead being placed upon illustrating the principles being described.

FIG. 1 illustrates a schematic diagram illustrating an example charged particle microscope system, in accordance with some embodiments of the present disclosure.

FIG. 2 illustrates a schematic diagram illustrating an example analytical system for generating microscope image data and template information, in accordance with some embodiments of the present disclosure.

FIG. 3 illustrates block flow diagram of an example process for generating template information using image data, in accordance with some embodiments of the present disclosure.

FIG. 4 illustrates a block diagram of an example object hierarchy describing the template information, in accordance with some embodiments of the present disclosure.

FIG. 5 illustrates a block flow diagram illustrating an example data flow involved in generating the template information, in accordance with some embodiments of the present disclosure.

FIG. 6 is a schematic diagram illustrating an example convolution technique for generating the template information, in accordance with some embodiments of the present disclosure.

FIG. 7 illustrates a block diagram of an example, non-limiting system that can facilitate a process for measurement device data comparison, in accordance with one or more example embodiments described herein.

FIG. 8 illustrates a block diagram of an example imaging and/or scientific measurement system, in accordance with one or more example embodiments described herein.

FIG. 9 illustrates a block diagram of an example, non-limiting dual beam system comprising an electron microscope (EM) and a focused ion beam (FIB) device, in accordance with one or more example embodiments described herein.

FIG. 10 illustrates an example lamellae that can be employed by the non-limiting system of FIG. 1, in accordance with one or more example embodiments described herein.

FIG. 11 illustrates an example template layout for integrated circuit (IC) devices that can be performed by the non-limiting system of FIG. 1, in accordance with one or more example embodiments described herein.

FIG. 12 illustrates a flow diagram of one or more processes that can be performed by the non-limiting system of FIG. 1, in accordance with one or more example embodiments described herein.

FIG. 13 illustrates a continuation of the flow diagram of FIG. 12 of one or more processes that can be performed by the non-limiting system of FIG. 1, in accordance with one or more example embodiments described herein.

FIG. 14 illustrates a block diagram of an example operating environment into which embodiments of the subject matter described herein can be incorporated.

FIG. 15 illustrates an example schematic block diagram of a computing environment with which the subject matter described herein can interact and/or be implemented at least in part.

### DETAILED DESCRIPTION

Semiconductor manufacturing makes use of charged particle microscopy, such as transmission electron microscopy, as part of quality control. In an illustrative example, samples of semiconductor devices (e.g., integrated circuits) are extracted from a wafer or wafer portion (e.g., a diced wafer) and examined in a transmission electron microscope. Microscope images of a so-called “device line,” referring to a linear arrangement of individual devices, such as transistors, capacitors, or the like, can be used to assess fabrication error and/or design error.

One aspect of quality control of semiconductor devices, therefore, includes determining whether a fabricated device conforms to the device design, with individual devices being present in the expected number and sequence at a given location on the wafer and/or wafer portion.

Typically, quality control of semiconductors is at least partially, if not entirely, manual. Sample preparation, including locating and extracting lamellae, generating microscope image data, and analyzing image data to determine whether the fabricated device conforms to device designs, among other operations, are executed by skilled technicians. Efforts to automate aspects of quality control processes face significant challenges, including image processing automation. Defect detection, for example, relies on correctly identifying regions of interest in a sample, generating images of the region of interest, and processing images via feature detection and recognition, pattern matching, and the like. Each of these operations are challenging for machine-vision systems that typically perform poorly when distinguishing IC devices from background, are prone to errors when a sample is inverted in the microscope, and/or are relatively inflexible when analyzing a device line sample that diverges from a predefined sequence. There is a need, therefore, for improved data processing techniques, methods, and/or algorithms for use in quality control of semiconductor fabrication.

Further, acquiring enough images through microscopy, such as for training analytical model for driving a workflow, is a time-consuming process. In existing frameworks, user entities bear the burden of investing a significant amount of time in data collection and model training.

With particular respect to lamellae, such as of wafers, IC devices, etc., real world images are time-consuming to gather and are often not applicable to every region of a same wafer due to differences in design along a die, for example.

To make up for one or more of these deficiencies, described herein are one or more embodiments that can provide for generating synthetic samples and/or sample data for use in training an analytical model, and/or for use of such trained model for controlling imaging systems, sample preparation systems, manufacturing and/or fabricating systems, and/or the like. In one or more embodiments, this can eliminate and/or reduce microscope time to capture real world sample images. Instead, user entities can access synthetically generated images of greater quantity, quality and variety. This can not only reduce preparation time, model training time, etc., but also can allow for generation more sophisticated automation workflows and computer vision models.

While illustrative embodiments have been illustrated and described, it will be appreciated that various changes can be made therein without departing from the spirit and scope of the disclosure. In the forthcoming paragraphs, embodiments of a charged particle microscope system, components, and methods for device detection and recognition in integrated circuit samples are described. Embodiments of the present disclosure focus on CMOS device samples imaged in a transmission electron microscope (TEM) in the interest of simplicity of description. To that end, embodiments are not limited to such samples or instruments, but rather are contemplated for analytical instrument systems where analysis of micro-structured and/or nanostructured features can benefit from robust automation (e.g., operation without human intervention) and/or pseudo-automation (e.g., operation with limited human intervention). In an illustrative example, techniques of the present disclosure can be applied to image data derived from microbiological processes (e.g., genetic sequencing outputs, fluorescence microscope images, etc.), metastructured materials (e.g., for quality control of fabricated hidden geometries), and/or for large-scale imaging of artificial or natural structures (e.g., survey data, such as hyperspectral imaging). Similarly, while embodiments of the present disclosure focus on TEMs, additional and/or alternative systems are contemplated, including but not limited to scanning electron microscopes (SEM), scanning-transmission electron microscopes (STEM), STEM-in-SEM, atomic-force microscopy (AFM), scanning capacitance microscopy (SCM), ion microscopy (IM), optical microscopy, confocal microscopy, fluorescence microscopy, hyperspectral imaging, or the like, where instruments are used to generate image data representing structures or other features that at least partially conform to a pattern.

Embodiments of the present disclosure can comprise systems, methods, algorithms, and non-transitory media storing computer-readable instructions for generating template information from image data. In an illustrative example, a method can include receiving microscope image data, detecting a feature in the microscope image data, receiving feature template data describing a grouping of features including the feature, detecting the grouping in the microscope image data based at least in part on the feature template data, generating template information for the grouping, and outputting the template information. As described in reference to the forthcoming embodiments, the hierarchical structure of template data permits systems of the present disclosure to efficiently process microscope image data, to detect features in arrangements corresponding to a design or other characteristic pattern, to determine regions of interest in a semiconductor sample for imaging, and to direct the systems to generate image data including the regions of interest. In this way, analytical instrument systems can perform template-driven image generation with reduced human interaction, with improved performance in terms of time and computational resource demand, while also reducing the level of technical complexity demanded of human operators of the instrument systems.

As used herein, the phrase “based on” should be understood to mean “based at least in part on,”unless otherwise specified.

As used herein, the term “compound” can refer to a single material, multiple materials, composition, sample, solution, product, etc.

As used herein, the term “data”can comprise metadata.

As used herein, the terms “entity,” “requesting entity,” and “user entity” can refer to a machine, device, component, hardware, software, smart device, party, organization, individual and/or human.

One or more example embodiments are now described with reference to the drawings, where like referenced numerals are used to refer to like drawing elements throughout. In the following description, for purposes of explanation, numerous specific details are set forth in order to provide a more thorough understanding of the one or more example embodiments. It will be evident, in one or more embodiments, however, that the one or more example embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

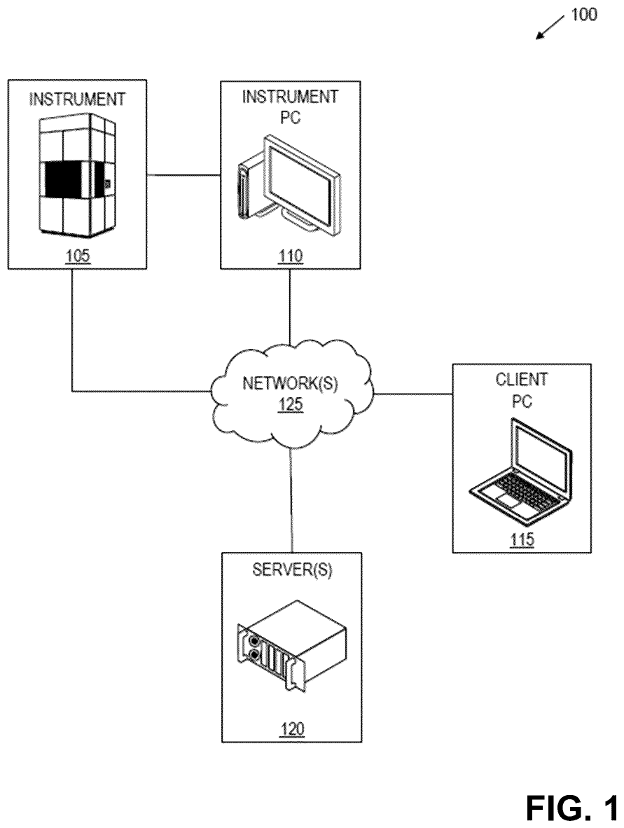

Turning first to FIG. 1, illustrated is a schematic diagram illustrating an example charged particle microscope system 100, in accordance with some embodiments of the present disclosure. The example system 100 can include one or more instrument systems 105, one or more instrument PCs (IPCs) 110, one or more client computing devices (client PCs) 115, and/or one or more servers.

120. The various components of the example system 100 can communicate via one or more networks 125 and/or via a direct connection (e.g., a USB-type connection, Bluetooth, Wi-Fi, ethernet, etc.). In some embodiments, one or more components of example system 100 are omitted. For example, embodiments of the present disclosure can omit the client PC(s) 115, and/or the server(s) 120.

The instrument system(s) 105 can include components for analyzing material samples according to one or more measurement modalities, facilitated by the configurations of the instrument(s) 105 and software, tools, or the like, available on the IPC(s) 110, the client PC(s) 115, and/or server(s) 120. For example, the client PC(s) 115 and/or server(s) 120 can host software applications configured to implement one or more processing operations using data generated by the instrument(s) 105. In this way, software applications can be hosted locally on individual devices and/or on distributed computing systems and operations of the instrument 105 can be directed based at least in part on template information generated from image data generated by the instrument 105.

The client computing device(s) 115 can be or include general purpose (e.g., laptops, tablets, smart phones, desktops, etc.) and/or special purpose computing devices. The server(s) 120 can be or include one or more local and/or remote network connected machines including processing, storage, and/or communication components. In an illustrative example, the server(s) 120 can be co-located with the instrument(s) 105 in a physical location (e.g., a building, campus, or other location), and can communicate with one or more components of the

instrument(s) 105. The client PC(s) 115 can be located at a first physical location different from a second physical location of the instrument(s) 105. To that end, constituent elements of the example system 100 can be co-located to store large datasets generated by the instrument system(s) 105 and to reduce data transfer latency during periods of relatively high network latency, or, for example, when the first physical location and the second physical location are physically remote (e.g., on different continents or different coasts of the same continent).

IPC(s) 110 can include general purpose or special purpose computing devices. For example, embodiments include a PC configured for user interaction (e.g., having display, user interaction peripherals, and user interface), a PC dedicated to coordinating the operation of the instrument(s) 105 without direct user interaction (also referred to as a “dedicated” PC) that lacks user interface components, and/or a compute board incorporated into or otherwise operably coupled with the instrument(s) 105. A compute board can include components similar to the dedicated PC, where power circuitry and/or input output components can be shared with the instrument(s) 105.

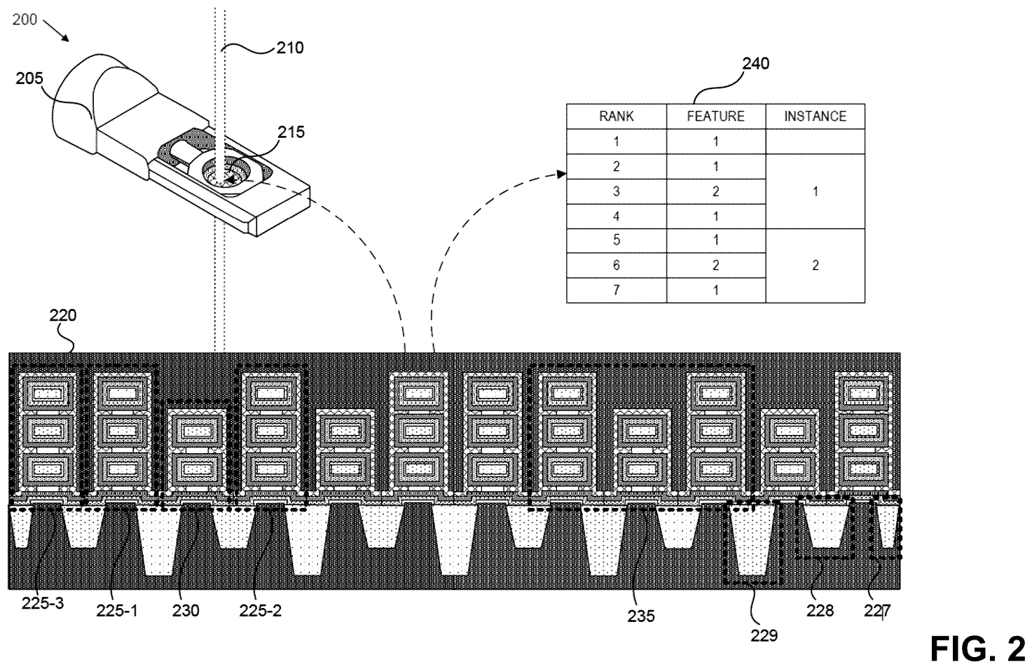

FIG. 2 is a schematic diagram illustrating an example analytical system 200 for generating microscope image data 220 and template information 240, in accordance with some embodiments of the present disclosure. In the illustrated embodiment, the example analytical system 200 includes a TEM sample 205, as an example of a form of sample used in the instrument 105 of example system 100. In this way, microscope image data 220 include microscope image(s) formed by passing a beam of charged particles 210 through a sample 215 that is at least partially transparent to electrons.

The example analytical system 200 of FIG. 2 illustrates a TEM sample, such that the beam of charged particles 210 is a beam of electrons. In some embodiments, the beam of charged particles 210 is or includes a beam of ions (e.g., extracted from an ion source such as a liquid metal ion source, a plasma-based ion source, or the like). Further, the beam of charged particles 210 is shown transiting through the sample 215, such that image data 220 corresponds to an image constructed with detector data generated from primary charged particles of the beam of charged particles 210 (e.g., primary electrons in the case of TEM system(s)). In some embodiments, the beam of charged particles 210 is focused onto the sample 215, such that the image data 220 can include backscattered electron, backscattered ion, secondary electron, and/or secondary ion detector data. In such cases, the sample 215 can be mostly or entirely opaque to charged particles, such as a bulk material sample or a sample having a thickness such that electron absorption and/or backscatter outweigh electron transmission.

Image data 220 illustrate a region of the sample 215 that includes features 225 and 230, disposed in an arrangement. The arrangement can be a linear arrangement and/or a non-linear arrangement. In the example of a semiconductor device, the features 225 and 230 can be arranged in a “device line,” which includes multiple instances of features 225 and 230 that are formed during a CMOS fabrication process. Features 225 and 230 can be or include at least part of various devices that make up a part of an integrated circuit, such as transistors, capacitors, vias, or the like. In one or more embodiments, the same device can be detected as more than one feature type, based at least in part on variation of a characteristic of the device. For example, size can be used to categorize a device into one of a set of feature types (e.g., small-type 227, middle-type 228, and large-type 229). Similarly, other characteristics, such as material composition, sub-features, etc., can be used (e.g., in one or more pre-processing operations) to define multiple feature-types.

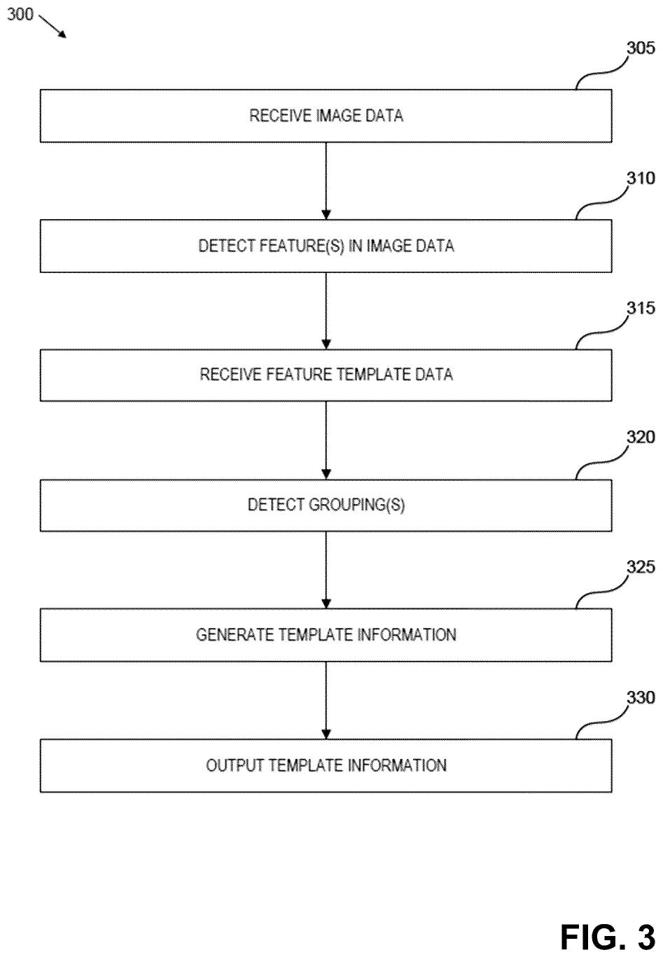

The image data 220 can include metadata, including but not limited to sample information, system parameters, and/or spatial/coordinate information. Spatial/coordinate metadata can map a pixel in the image data 220 to a set of coordinates of a position on the sample 205. In one or more embodiments, the coordinates can reference a stage control scheme, such as a multi-axis sample holder (e.g., three spatial directions and tilt). In this way, features 225 and 230 can be referenced by a position on the sample 205 and in the image data 220. For example, a feature can be referenced by a position of a centroid of the feature in the image data 220 and/or on the sample 205. The extents, centroid, and other geometric characteristics of various features can be determined based at least in part on segmentation processes applied to the image data 220. Additionally, and/or alternatively, dimensions, extents, and/or centroids of the various features can be determined based at least in part on detection of one or more edges, vertices, or other aspects of the features, from which a pre-defined centroid can be referenced. For example, a vertex between a top edge and a side edge of a given feature can be referenced to define a centroid, based on a design specification of the given feature. As described in more detail in reference to FIG. 3, the position of the centroid can be referenced to a bounding box used to define a region of interest (ROI) for further microscopy and/or microanalysis (e.g., by imaging or probing).

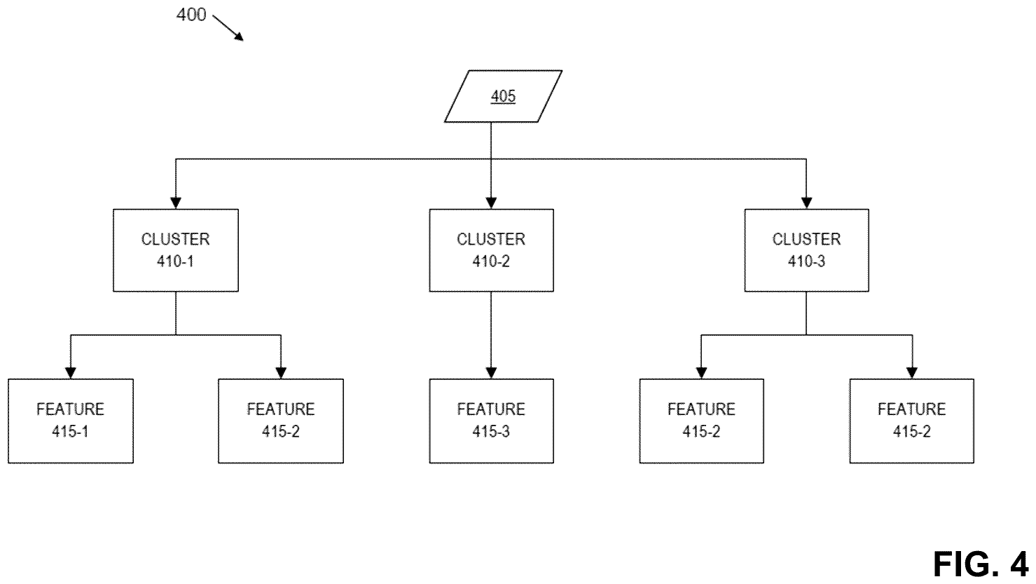

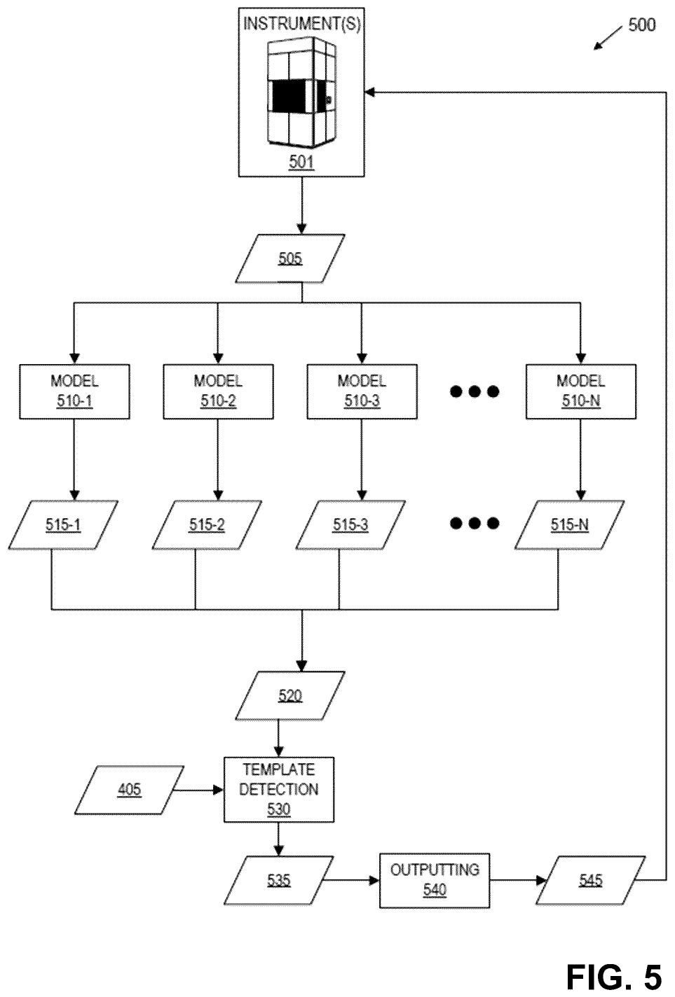

To that end, techniques of the present disclosure can include processes applied to image data 220, from which the observed arrangement of the features 225 and/or 230 can be compared to feature template data (e.g., feature template data 405 of FIGS. 4 and 5), as an approach to guiding microscopy and microanalysis of the sample 205. The features 225 and 230 illustrated in FIG. 2 are schematic in nature, and do not represent the shape or scale of actual semiconductor devices. Instead, image data 220 is provided as an illustrative example of features arranged in the sample 215, from which the template information 240 can be generated. Further, while the image data 220 includes two types of features, techniques of the present disclosure can be applied to image data describing samples that include more or fewer feature types.

The template information 240 can include data for the features 225 and 230 including a feature sequence, such as a number of instances of a first feature type 225 and a number of instances of a second feature type 230 in a grouping 235. As such, the template information 240 can include a sequence of features (e.g., in order of respective position in an arrangement), where the grouping 235 corresponds to the sequence of features. In the example of FIG. 2, a template corresponds to a sequence of features in a device line, for which the grouping 235 includes a first instance of the first feature 225-1, an instance of the second feature 230, and a second instance of the first feature 225-2. The image data 220 can describe multiple instances of the grouping 235, and not all features 225 and/or 230 can belong to a grouping instance (e.g., third instance of the first feature 225-3). As described in more detail in reference to FIG. 3, the template information 240 can be generated by processing the image data 220 using algorithm(s) for detecting features in the image data 220, recognizing the arrangement of the features in grouping(s) in correlation with feature template data, and generating information describing the position(s) and sequence of the groupings to be used for investigating the structure of a sample.

FIG. 3 is a block flow diagram of an example process 300 for generating template information using image data, in accordance with some embodiments of the present disclosure. One or more operations making up the example process 300 can be executed and/or initiated by a computer system and/or other machine operably coupled with components of an analytical instrument (e.g., example the instrument(s) 105 of FIG. 1) and/or additional systems or subsystems including, but not limited to, characterization systems, network infrastructure, databases, controllers, relays, power supply systems, and/or user interface devices. To that end, operations can be stored as machine executable instructions in one or more machine readable media that, when executed by the computer system, can cause the computer system to perform at least a portion of the constituent operations of the process 300. The constituent operations of the process 300 can be preceded by, interspersed with, and/or followed by operation(s) that are omitted from the present description, such as sample and/or instrument preparation, operations that take place prior to operations 305, or the like, that form at least a part of an analytical method for processing a sample to generate data as illustrated in FIG. 2. To that end, operations of the example process 300 are be omitted, repeated, reordered, and/or replaced in some embodiments.

At operation 305, example process includes receiving image data (e.g., image data 220 of FIG. 2). Receiving image data can include various sub-operations associated with data storage and retrieval. For example, image data can be stored in a local storage system and/or distributed storage system(s), such that a computing device (e.g., IPC 110, client PC 115, server(s) 120, etc. Of FIG. 1) can request, retrieve, or otherwise access image data for a given sample. In some embodiments, receiving image data includes generating the image data, as described in more detail in reference to FIG. 2. To that end, example process 300 can be implemented by one or more computing systems concurrent with imaging a sample in a charged particle microscope, for example, as part of a semiconductor quality control scheme. In an illustrative example, microscope image data (e.g., image data 220 of FIG. 2) can be generated and transferred from the charged particle microscope (e.g., instrument 105 of FIG. 1) to a computing device or other machine that is implementing operations of the example process 300.

At operation 310, example process includes detecting one or more features in the image data. Feature detection can include one or more techniques, based at least in part on image processing and/or segmentation, that permits the detection and/or recognition of features (e.g., features 225 and 230 of FIG. 2) in image data. Detecting the one or more features can include inputting at least a portion of the microscope image data to a model configured to detect the feature, and generating, as an output of the model, coordinate information describing a location of the feature in the microscope image data. As described in more detail in reference to FIGS. 4 and 5, the model can be or include various model structures configured to input at least a portion of the microscope image data and to output information describing the rank, position, and/or size of a given feature, among other information that can be used for detecting groupings (e.g., grouping 235 of FIG. 2) in the microscope image data. Model structures can include rules-based models, feature detection algorithms (e.g., Sobel filter-based edge detection, Gabor filter-based texture analysis, or the like), neural network-based models (e.g., convolutional neural networks), pixel-based classification methods, patch-based image classification methods, or the like.

In some embodiments, multiple models are used to detect multiple features in the image data. Models can be configured to detect a respective feature type, such that for a given number of features to be detected in the microscope image data, the same number of models are prepared. For example, two convolutional neural network models can be trained as part of preparatory operations for the example process 300, such that a first model detects a first feature type and a second model detects a second feature type. To that end, detecting the one or more features in the image data can include inputting at least a second portion of the microscope image data to a second model configured to detect a second feature and generating, as an output of the second model, second coordinate information describing a second location of the second feature in the microscope image data. In one or more embodiments, the complete microscope image dataset is processed, being inputted to multiple models. In one or more embodiments, however, operation 310 can include sub-operations, such as segmentation and pre-processing (e.g., feature-agnostic) to separate features into smaller datasets, thereby reducing the volume of data processed by the models. The smaller datasets can be labeled with a grid reference or other index, as an approach to tracking the rank of the feature in a sequence, as described in more detail in reference to FIG. 2 and FIGS. 5 and 6.

At operation 315, example process includes receiving feature template data. As described in more detail in reference to FIG. 2, and FIGS. 4 to 6, feature template data (e.g., feature template data 405 of FIG. 4) can describe an arrangement of multiple features (e.g., features 225 and 230 of FIG. 2). For example, feature template data can describe a spatial arrangement of the multiple features, using relative coordinates that can be compared to detected features in microscope image data. In a simpler example, feature template data can describe a sequence of multiple features, where feature(s) are attributed a sequence position (e.g., using integer ranking). In this way, feature template data can describe the expected arrangement of features in a sample (e.g., sample 215 of FIG. 2) to be used as part of microscopy, microanalysis, and/or quality control review of samples, such as integrated circuit samples. Feature template data can include metadata, such as feature type, feature dimensions, relative positions of centroids, or other information that can be used to map the arrangement of features in the microscope image data to a feature template. In some embodiments, feature template data includes feature multiplicity information and feature order information. Feature multiplicity can describe a number of instances of a given feature, while feature order information can describe the relative rank of features in a sequence. In some embodiments, a template can include multiple groupings (e.g., grouping 235 of FIG. 2), as described in more detail in reference to FIG. 4.

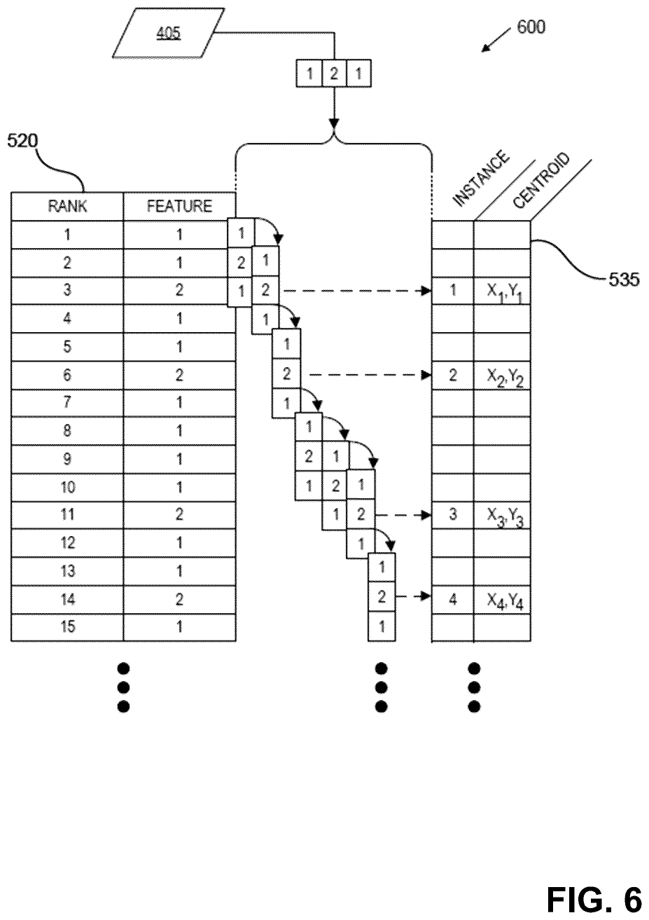

At operation 320, example process includes detecting one or more groupings. The groupings (e.g., grouping 235 of FIG. 2) can include multiple instances of features in the microscope image data. For example, a grouping can include one or more instances of a first feature, one or more instances of a second feature, and one or more instances of a third feature, in an arrangement. Detecting the groupings can include one or more approaches using data generated at operation 310. For example, rank data generated by feature detection can be convolved with feature template data, as described in more detail in reference to FIG. 6.

Detecting the one or more groupings can include detecting an instance of the grouping in the microscope image data based at least in part on a location of a feature relative to at least a subset of the multiple features in a sequence. In this way, detecting an instance of the grouping in the microscope image data can include determining a first rank of the first feature in a sequence and determining that the first rank of the first feature and a second rank of a second feature in the sequence match the feature template data. For example, detecting a grouping can include finding a matching sequence of features in the arrangement (e.g., a first feature, followed by a second feature, followed by a first feature, as illustrated in FIG. 2 and in FIG. 6, can be identified as a grouping).

Grouping detection can be based at least in part on feature multiplicity and/or feature order, as described in reference to operation 315. For some analytical instrument systems (e.g., TEM systems, STEM systems, or the like), a sample (e.g., sample 215 of FIG. 2) can be introduced into the sample holder in more than one orientation. For example, in a TEM holder, a lamella can define two broad faces, either of which can be oriented toward the incident beam of electrons (e.g., beam of charged particles 210 of FIG. 2). In this way, the feature template data can describe order information that can be directly mapped to the observed features detected in the microscope image data, or mapped to an inverse arrangement (e.g., a mirror-inverse), resulting from the inversion of the sample in the analytical instrument system. As such, operation 320 can include detecting an instance of a grouping based on an inverse feature order. In an example, an inverse feature order of a template having two first features followed by one second feature, in a linear arrangement, would be a sequence of one second feature followed by two first features.

At operation 325, example process includes generating template information. Template information can include metadata derived from the microscope image data, based at least in part on the grouping(s) detected at operation 320. For example, template information derived from a given grouping can include coordinates of the grouping that, without limitation, can include a position of the grouping in the microscope image data and/or in the sample. The position of the grouping can be described using a centroid or other substantially centered position of the grouping, extents of the grouping (e.g., a four-corners set of coordinates, a bounding-box, or the like), a vertex or other peripheral coordinate and/or origin of a bounding box circumscribing the grouping, contour data, or the like. Advantageously, defining a position of a grouping using a centroid or other substantially centered position can permit instructions to be generated for the analytical instrument to cause the instrument to generate new image data, for which the region of interest is centered, substantially centered, or includes the grouping. In this way, the groupings can be detected in microscope image data at relatively low magnification and analyzed in new microscope image data at relatively high magnification in an automated or pseudo-automated approach.

At operation 330, example process includes outputting template information. Operation 330 can include sending the template information to a charged particle microscope, the charged particle microscope being configured to generate image data based at least in part on the template information, as described in reference to operation 325. In some embodiments, operation 330 includes storing template information, which can include transferring the template information between computing devices (e.g., over network(s) 125 of FIG. 1).

Operation 330 can also include generating visualization data based at least in part on the template information. Visualization data can include instructions configured to modify a display or other device for presenting the template information as part of a user environment (e.g., a browser or application environment on a display) on a computing device (e.g., IPC 110 and/or client PC 115 of FIG. 1). In an illustrative example, visualization data can be generated to modify a display to overlay a bounding box on a region of the microscope image data, where the bounding box represents the region of interest substantially centered on one or more groupings. In some embodiments, operation 330 includes outputting feature and/or grouping information, such that visualization data can include feature rank, feature identifier, feature centroid, grouping centroid, grouping instance number, and/or template order information, among other types of information. Operation 330, therefore, can include outputting information from multiple hierarchical levels of feature, grouping, and template, that permits a sample to be systematically and efficiently interrogated by an automated and/or pseudo-automated technique.

FIG. 4 is a block diagram of an example object hierarchy 400 describing the template information, in accordance with some embodiments of the present disclosure. The example hierarchy 400 includes a top-level object associated with feature template data 405, comprising data for multiple clusters 410, in turn comprising one or more features 415. The example hierarchy 400 includes three tiers of objects described in image data (e.g., image data 220 of FIG. 2), but template information can include more or fewer tiers of objects. For example, a grouping (e.g., grouping 235 of FIG. 2) can represent a template or a cluster 410.

The features 415 can be of one or more types, as described in more detail in reference to FIG. 2. As such, each feature 415 type can be associated with a model configured to detect the feature 415 type in image data. The models can generate metadata used to detect the cluster(s) 410 and/or the template(s) 405 in the image data, as described in more detail in reference to FIG. 3 and FIGS. 5 and 6. Similarly, clusters 410 can represent a combination of features and/or compound features that are described in a device design, expected arrangement, or the like, such that detecting a cluster 410 can be computationally simpler than detecting the constituent features 415. In an illustrative example, a device line can include clustered contiguous features, making an outer boundary of the cluster suitable for detecting the cluster, in addition to or instead of detecting individual features making up the cluster. As such, one or more models can be configured to detect cluster(s) 410 in the image data.

FIG. 5 is a block flow diagram illustrating an example data processing workflow 500 involved in generating the template information, in accordance with some embodiments of the present disclosure. The data processing workflow 500 includes one or more processing operations applied to data 505 generated by analytical instrument(s) 501 (e.g., the instrument(s) 105 of the example system 100 of FIG. 1). The operations of the example workflow 500 are shown as a sequence of operations unassociated from a particular instrument, computing device, or machine, as an approach to illustrate that multiple data types and/or data structures are generated at various points in the example workflow 500. Further, the example workflow 500 includes at least a subset of processing operations that are implemented in parallel, for example, by distributing operations over multiple computing devices (e.g., server(s) 120 of FIG. 1) and/or by processing the data 505 on a multi-core processor.

The data 505 can be or include image data (e.g., microscope image data 220 of FIG. 2), but can also include other data describing a sample (e.g., sample 215 of FIG. 2). For example, the data can be optical image data, generated using optical microscopes and/or cameras, spectral mapping image data, generated using spatially resolved spectrometry, force-microscopy data mapping electronic properties of a sample surface in two or more dimensions, or the like.

The data 505 can be distributed, in whole or in part, to one or more models 510, configured to detect features (e.g., features 225 and 230 of FIG. 2 and features 415 of FIG. 4) and/or groupings of features (e.g., clusters 410 of FIG. 4) in the data 505. As described in more detail in reference to FIG. 3, the data 505 can be segmented by one or more pre-processing operations, as an approach to improving parallelization, and model(s) 510 can be or include various types of image processing models and/or algorithms (e.g., CNN-type machine-learning models, patch-based processing algorithms, etc.). In this way, the output from model(s) 510 can be or include data 515 describing feature information, such as rank, location in the image data, and/or location in the sample. The data 515 output from the model(s) 510 can be combined to generate aggregated data 520 and provided to a template detection sub-process 530. As described in more detail in reference to FIG. 6, one or more template detection sub-processes 530 can be configured to map feature template data 405 to the output data 515 and/or aggregated data 520. In one or more embodiments, template detection sub-process 530 can be implemented as an algorithm configured to generate template information 535, as described in more detail in reference to FIG. 3.

The template information 535 can include template locations, ROI data, feature sequence data, such as feature multiplicity and order information observed in the sample, template instance information, or other data permitting the further interrogation of the sample by a user of the analytical system (e.g., example system 100 of FIG. 1) or by the instrument (e.g., when operating automatically and/or pseudo-automatically). The template information 535, in turn, can be provided as input to an outputting sub-process 540 that can be or include one or more algorithms for generating visualization data, sample positioning instructions, beam direction instructions, detector operating instructions, instrument operating parameters, or the like. In an illustrative example, the outputting sub-process 540 can generate instruction data 545 to guide the instrument 501 in generating additional data, based at least in part on the template(s) information 535 generated using the data 505.

FIG. 6 is a schematic diagram illustrating an example convolution technique 600 for generating the template information, in accordance with some embodiments of the present disclosure. The example technique 600 includes mapping feature template data 405 onto output data 515 and/or aggregated data 520 describing feature rank and identity information for a device-line sample. In the example technique 600, the feature template data 405 describes a grouping (e.g., grouping 235 of FIG. 2) including a first instance of a first feature, followed by a first instance of a second feature, followed by a second instance of the first feature. The convolution approach includes mapping the feature template data 405 onto the sequence of features in the aggregated data 520 determining whether the features match the template, followed by incrementing the template by one rank if the features don't match the template, or by one template-length where the features do match the template. For one or more of the templates that are detected (e.g., each of the templates or fewer), an instance number can be attributed, as well as various location/position data referencing the template's relative position in the image data and/or on the sample. In FIG. 6, the data include centroid positions referencing an X-Y coordinate in the image or on the sample.

In some embodiments, additional and/or alternative techniques are used for mapping feature template data 405 to aggregated data 520, as part of generating feature information 535 for the sample. For example, a technique for measuring an error or distance between the template and measured features (e.g., mean-square error) can be used to generate feature information 535. Similarly, template matching approaches can include outlier rejection (e.g., random sample consensus techniques) to improve matching in noisy data. Advantageously, template matching approaches can be extended to higher dimensions. Embodiments of the present disclosure include two-dimensional convolution (e.g., along a second axis in an array of features).

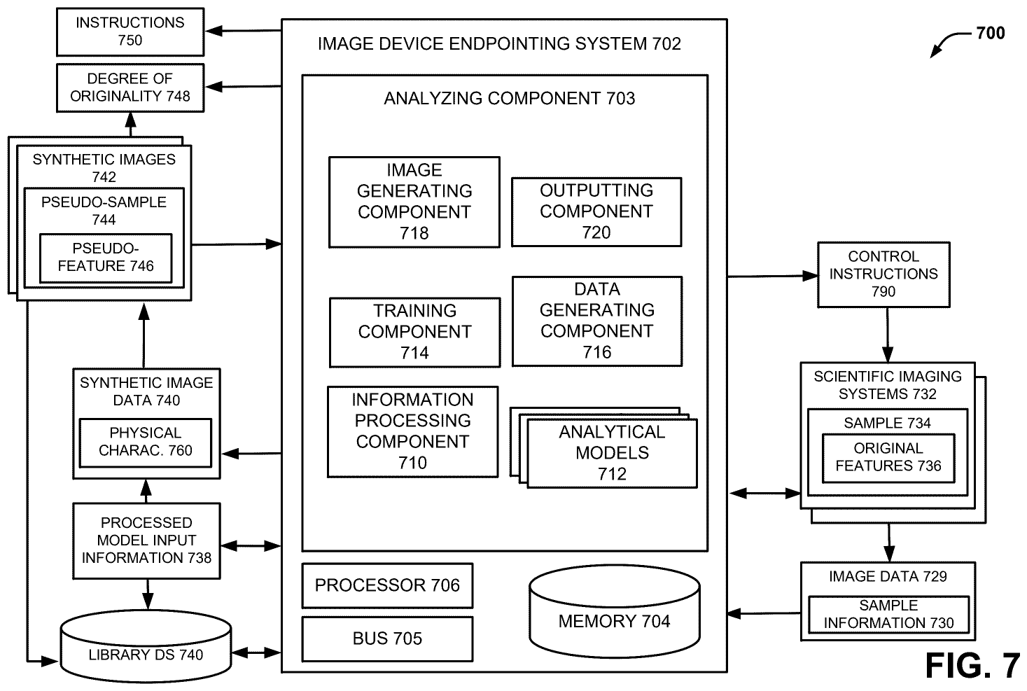

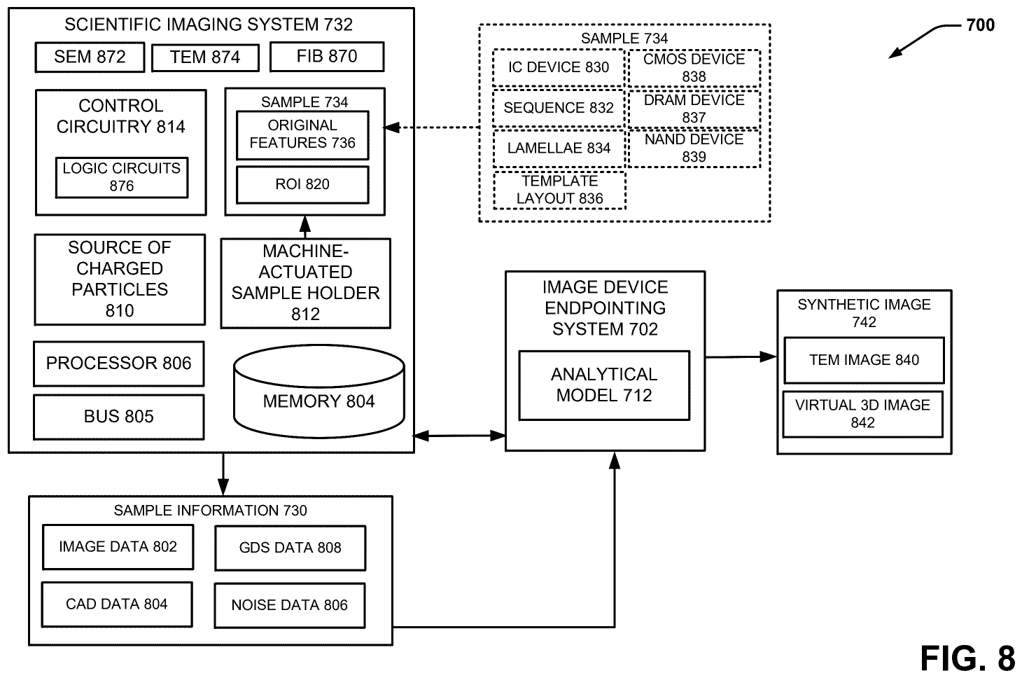

Turning now to FIG. 7, a non-limiting system 700 is illustrated that can comprise an image device endpointing system 702, a scientific imaging system 732 and a library datastore (DS) 740. Repetitive description of like elements and/or processes employed in respective embodiments is omitted for sake of brevity. Description relative to an embodiment of FIG. 7 can be applicable to an embodiment of FIG. 8. Likewise, description relative to an embodiment of FIG. 8 can be applicable to an embodiment of FIG. 7.

In one or more embodiments, the scientific imaging system 732, such as a dual beam system, focused ion beam (FIB) system, or electron microscope (EM) system device, can be separate from but communicatively couplable to the non-limiting system 700. In one or more other embodiments, the scientific imaging system 732 can comprise the image device endpointing system 702.

In one or more embodiments, one or more additional scientific imaging systems likewise can be communicatively couplable with the non-limiting system 700 and/or comprised by the non-limiting system 700.

In one or more embodiments, the library datastore 740 be separate from but communicatively couplable to the non-limiting system 700.

Generally, the image device endpointing system 702 can facilitate generation of synthetic image data 740 for use in training an analytical model 712 and/or for generating instructions 750 for controlling operation of the scientific imaging system 732 or other scientific imaging system.

One or more communications between one or more components of the non-limiting system 700 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

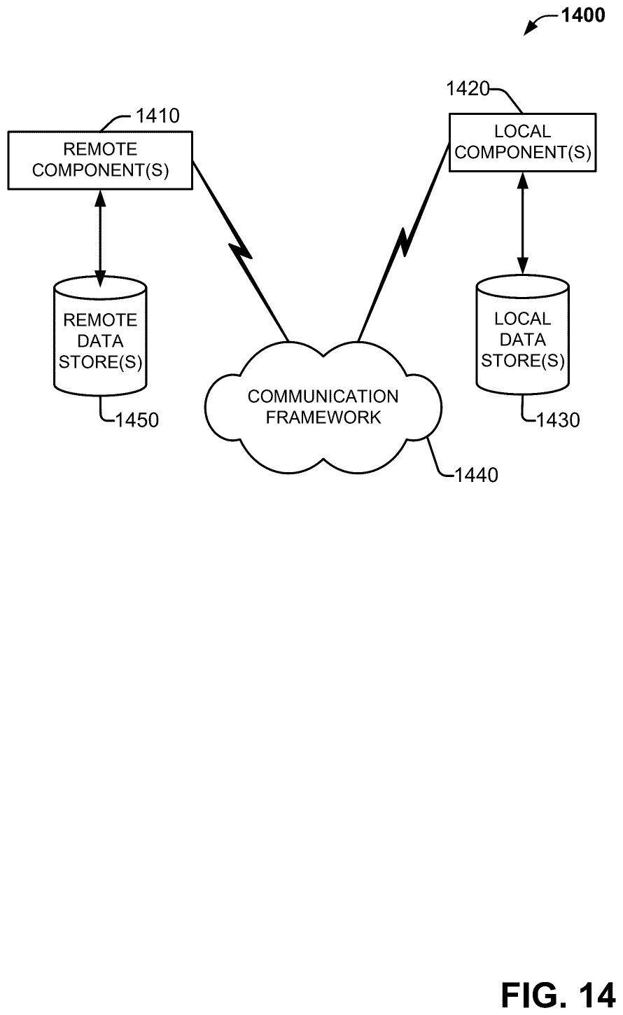

The image device endpointing system 702 can be associated with, such as accessible via, a cloud computing environment, such as the cloud computing environment 1400 of FIG. 14.

The image device endpointing system 702 can comprise a plurality of components. The components can comprise a memory 704, processor 706, bus 705, information processing component 710, analytical model 712, training component 714, data generating component 716, image generating component 718, and/or outputting component 720. Using these components, the image device endpointing system 702 can facilitate generation of synthetic image data 740 for use in training an analytical model 712 and/or for generating instructions 750 for controlling operation of the scientific imaging system 732 or other scientific imaging system.

Discussion next turns to the processor 706, memory 704 and bus 705 of the image device endpointing system 702. For example, in one or more example embodiments, the image device endpointing system 702 can comprise the processor 706 (e.g., computer processing unit, microprocessor, classical processor, quantum processor and/or like processor). In one or more example embodiments, a component associated with image device endpointing system 702, as described herein with or without reference to the one or more figures of the one or more example embodiments, can comprise one or more computer and/or machine readable, writable and/or executable components and/or instructions that can be executed by processor 706 to provide performance of one or more processes defined by such component and/or instruction. In one or more example embodiments, the processor 706 can comprise the information processing component 710, analytical model 712, training component 714, data generating component 716, image generating component 718, and/or outputting component 720.

In one or more example embodiments, the image device endpointing system 702 can comprise the computer-readable memory 704 that can be operably connected to the processor 706. The memory 704 can store computer-executable instructions that, upon execution by the processor 706, can cause the processor 706 and/or one or more other components of the image device endpointing system 702 (e.g., information processing component 710, analytical model 712, training component 714, data generating component 716, image generating component 718, and/or outputting component 720) to perform one or more actions. In one or more example embodiments, the memory 704 can store computer-executable components (e.g., information processing component 710, analytical model 712, training component 714, data generating component 716, image generating component 718, and/or outputting component 720).

The image device endpointing system 702 and/or a component thereof as described herein, can be communicatively, electrically, operatively, optically and/or otherwise coupled to one another via a bus 705. Bus 705 can comprise one or more of a memory bus, memory controller, peripheral bus, external bus, local bus, quantum bus and/or another type of bus that can employ one or more bus architectures. One or more of these examples of bus 705 can be employed.

In one or more example embodiments, the image device endpointing system 702 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more example embodiments, one or more of the components of the image device endpointing system 702 and/or of the non-limiting system 700 can reside in the cloud, and/or can reside locally in a local computing environment (e.g., at a specified location).

In addition to the processor 706 and/or memory 704 described above, the image device endpointing system 702 can comprise one or more computer and/or machine readable, writable and/or executable components and/or instructions that, when executed by processor 706, can provide performance of one or more operations defined by such component and/or instruction.

Discussion next turns to the additional components of the image device endpointing system 702 (e.g., information processing component 710, analytical model 712, training component 714, data generating component 716, image generating component 718, and/or outputting component 720).

Processes performed by the image device endpointing system 702 can generally be broken down into various sets of processes including, but not limited to a first set of processes for generation of synthetic images based on original sample information and/or images, a second set of processes for training of an analytical model using the synthetic images, and a third set of processes for operation of a scientific imaging system using a trained analytical model and/or using one or more synthetic images generated by a system described herein.

First, it is noted that in one or more example embodiments, the information processing component 710, analytical model 712, training component 714, data generating component 716, image generating component 718, and/or outputting component 720 can be implemented independently, without one or more other of the information processing component 710, analytical model 712, training component 714, data generating component 716, image generating component 718, and/or outputting component 720. Additionally and/or alternatively, the information processing component 710, analytical model 712, training component 714, data generating component 716, image generating component 718, and/or outputting component 720 can be comprised by a high-level analyzing component 703, one or more of the below-described functions of the information processing component 710, analytical model 712, training component 714, data generating component 716, image generating component 718, and/or outputting component 720 can be performed by the high-level analyzing component 703, and/or the information processing component 710, analytical model 712, training component 714, data generating component 716, image generating component 718, and/or outputting component 720 can be omitted with the high-level analyzing component 703 performing one or more of the below-described functions of the one or more omitted information processing component 710, analytical model 712, training component 714, data generating component 716, image generating component 718, and/or outputting component 720.

As noted above, a first set of one or more processes can comprise generation of synthetic images based on original sample information and/or images. It is noted that this first set of one or more processes provides at least a partial summary of the subject matter discussed above with reference to FIGS. 1 to 6.

Turning first to the information processing component 710, this component can generally acquire (e.g., obtain, download, upload, request, transmit, etc.) sample information 730 output form the scientific imaging system 732. The information processing component 710 can store this sample information 730 either temporarily and/or more permanently at the library datastore 740, for example, in any suitable format. The sample information 730 can comprise data and/or metadata in any suitable format.

The information processing component 710 can process the sample information 730, which can describe a set of original features 736 of a sample 734, into processed model input information 738. This processing can comprise any suitable process of transposing, transforming, converting, adding, deleting, noise cancellation, noise removal, etc.

In an example embodiment, the processed model input information 738 can describe a sequence 832 of integrated circuit (IC) devices 830 comprising one or more groupings (e.g., clusters 410) of the IC devices 830 arranged relative to one another by specified relationships among features of the IC devices 830.

Turning to FIG. 8, and still referring to FIG. 7, the sample 734 can comprise any suitable scientific sample, such as an integrated circuit (IC) device 830, a sequence 832 of IC devices 830, a lamellae 834 (whether biological, of an IC device 830, etc.), a template layout 836 of workflow images for use in operating the scientific imaging system 732, a complementary metal-oxide semiconductor (CMOS) device 838, dynamic random-access memory (DRAM) device 837, and/or NOT-AND (NAND) device 839.

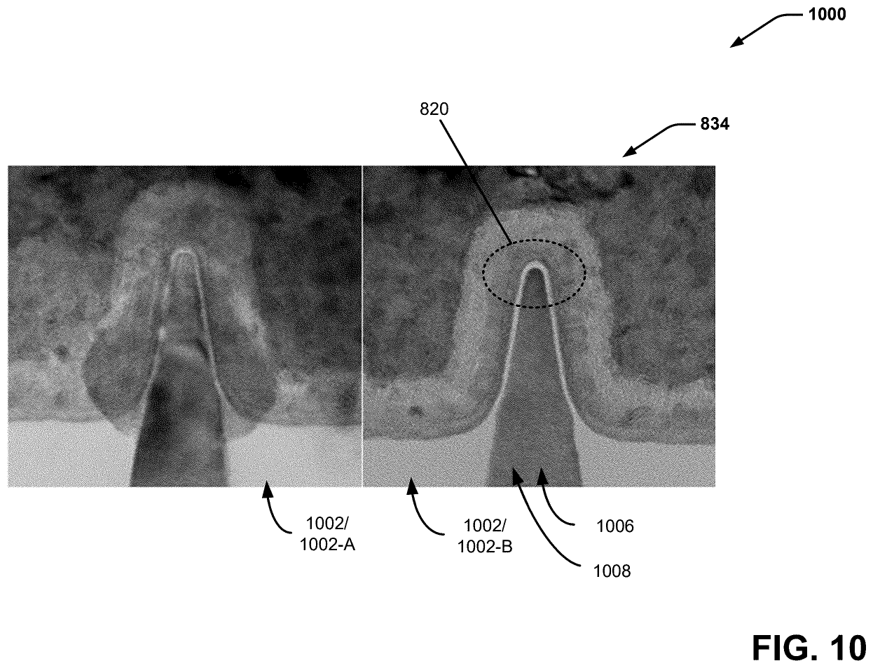

For example, turning to FIG. 10, illustrated are a pair of lamellae 1002 (e.g., lamellae 1002-A and 1002-B). Each lamellae 1002 has a cut surface 1006 provided at a plane 1008 of the lamellae.

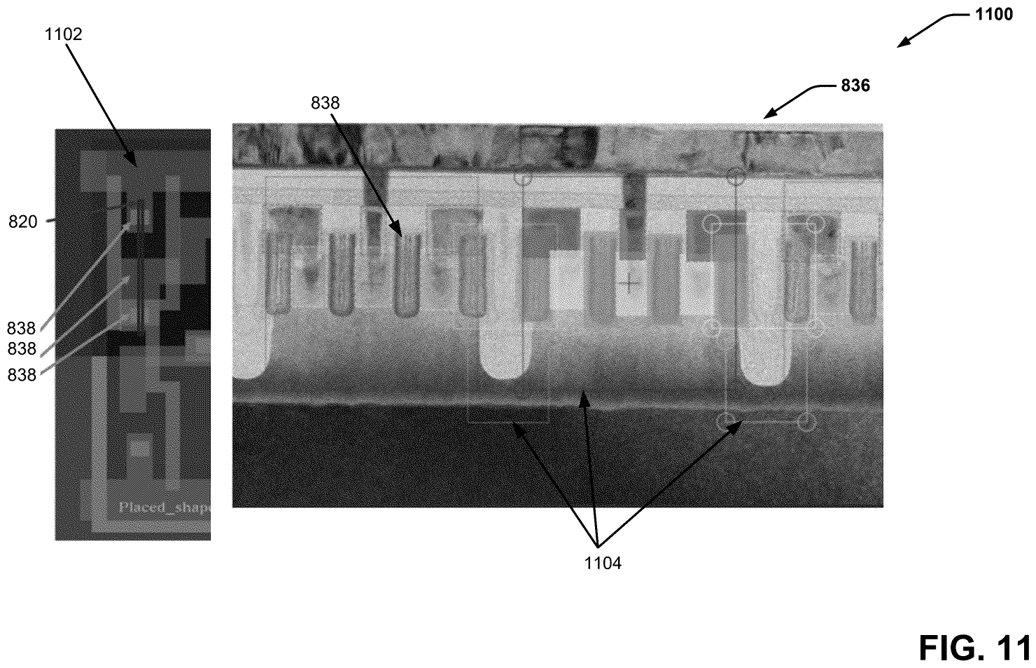

For another example, turning to FIG. 11, illustrated is an example template layout 836. The template layout 836 comprises a sequence of CMOS devices 838 and represents a set of workflow processes for identifying and imaging one or more regions of interest 820. In one or more other embodiments, the template layout 836 can comprise a sequence 832 of IC devices 830. As illustrated at the left image, a template 1102 is generated and overlayed atop the sequence based on nearby semiconductor device, such as CMOS devices 838. Each colored box 1104 of the template layout 836 can represent a step in a workflow set of processes.

Accordingly, turning back to FIGS. 7 and 8, the sample information 730 can comprise various information.

For example, the sample information 730 can comprise image data 802 describing an integrated circuit (IC), wherein the set of original features 736 comprises one or more IC devices 830 of the integrated circuit, and wherein the synthetic image data 740 comprises one or more physical characteristics 760 of the one or more IC devices 830. Physical characteristics 760 can comprise, but are not limited to, shape, position, orientation, surface height, dimensioning, etc.

In another example, the sample information 730 can comprise computer-aided drafting (CAD) data 804 describing the set of original features 736 and associated noise data 806 in an image format.

In still another example, the sample information 730 can comprise graphic data system formatted data (GDS or GDSII) or open artwork system interchange standard formatted data (OASIS).

Still referring to FIGS. 7 and 8, the data generating component 716 can generate synthetic image data 740 describing at least a portion of the set of original features 736 and be based on the processed model input information 738.

One or more synthetic image datasets 740 can be generated based on any one set of sample information 730 corresponding to a single sample 734.

In one or more embodiments, the synthetic image data 740 can describe at least one pseudo-feature that is different from, but based on, the original features 736. In this way, using the one or more example embodiments described herein, sample variety can be provided that otherwise may not be available in existing frameworks using all real world samples (e.g., samples 734).

In one or more examples, the sample information 730 and the synthetic image data 740 each can describe a region of interest 820 described in reference to computer-aided drafting (CAD) data 804, GDS data 808, and/or other image data 802, describing only a portion of the sample 734.

The image generating component 718 can generally generate a synthetic image 742 of a pseudo-sample 744, based on the synthetic image data 740, having at least one pseudo-feature 746 that is different from and based on the set of original features 736.

In one or more embodiments, the synthetic image 742 can comprise a synthetic transmission electron microscope (TEM) image 840 defined by the synthetic image data 740.

Turning briefly again to FIG. 10, in one or more embodiments, the synthetic image 742 can comprise a virtual three-dimensional (3D) image 842. The outputting component 720 and/or a component of the scientific imaging system 732 can virtually slice the virtual three-dimensional image 842 at a virtual plane 1008 of the virtual three-dimensional image 842. Further, the outputting component 720 can identify a region of interest 820 of a resulting slice of the three-dimensional image 842 based on a difference between a region of interest 820 of the slice as compared to a surrounding slice surface 1006 of the slice.

As illustrated at FIG. 10, as compared to existing frameworks, use of CAD data 804 and/or other synthetic image data 740 can result in a synthetic cut surface 1006 and/or lamellae image having a clearer region of interest 820 characterized by less noise data 806. This can be at least in part due to the virtual slicing of a virtual 3D image 842.

In one or more embodiments, the outputting component 720 can output the synthetic image 742 to the scientific imaging system 732 and/or to a display, screen, graphical user interface, etc. that is communicatively coupled to the image device endpointing system 702.

In one or more embodiments, the outputting component 720 can output the synthetic image 742 and associated synthetic image data 740 to the training component 714 and/or analytical model 712.

Referring now to the second set of one or more processes described above, the second set can comprise training of an analytical model using the synthetic images.

For example, dozens, hundreds or even thousands of synthetic images 742 can be generated for training the analytical model 712 using the training component 714. These synthetic images 742 can be generated using reduced power, bandwidth, time, manual labor, etc. as compared to existing frameworks employing real world samples 734.

The analytical model 712 can comprise an artificial intelligence model, machine learning model, language model, imaging model, neural network (NN) model, convoluted neural network (CNN) model, etc.

In one or more embodiments, the analytical model 712 can comprise an adversarial component, a generative adversarial network (GAN), diffusion model, a neural network model, or a convolutional neural network model that is trained using a training dataset of synthetically-generated images 742 of integrated circuit devices 830, lamellae 834 cut surfaces 1006 or transmission electron microscope workflow images (e.g., comprised by a template layout 836).

Based on the training of the analytical model 712, the analytical model 712, employing the data generating component 716, can virtually slice the virtual three-dimensional image 842 at a virtual plane 1008 of the virtual three-dimensional image 842. Further, the outputting component 720 can identify a region of interest 820 of a resulting slice of the three-dimensional image 842 based on a difference between a region of interest 820 of the slice as compared to a surrounding slice surface 1006 of the slice.

As noted above relative to image preparation for training the analytical model 712, also in use of the analytical model 712, use of CAD data 804 and/or other synthetic image data 740 can result in a synthetic cut surface 1006 and/or lamellae image having a clearer region of interest 820 characterized by less noise data 806. This can be at least in part due to the virtual slicing of a virtual 3D image 842.

Also based on the training of the analytical model 712, in a work process, the analytical model 712, can receive/acquire a sample image and/or sample data (e.g., sample information 730) from a scientific imaging system 732 (e.g., using the information processing component 710). Based on the training of the analytical model 712, the analytical model can identify a region of interest 820 of the sample 734 for being operated on by the scientific imaging system 732.

In one or more embodiments, the analytical model 712 can reference a degree of originality 748 when generating the synthetic image data 740 and/or when analyzing sample information 730/processed model input information 738. The degree of originality 748 can describe a variability relative to the sample information 730 or relative to a dataset used to train the analytical model 712.

Discussion next turns to the third set of one or more processes described above, which can comprise operation of a scientific imaging system using a trained analytical model and/or using one or more synthetic images generated by a system described herein (e.g., the non-limiting system 100 of FIG. 7).

That is, further based on the training of the analytical model 712, in a work process, the analytical model 712, can generate one or more control instructions 790 to cause one or more logic circuits 876 (e.g., of control circuitry 814) of the scientific imaging system 732 to perform one or more operations.

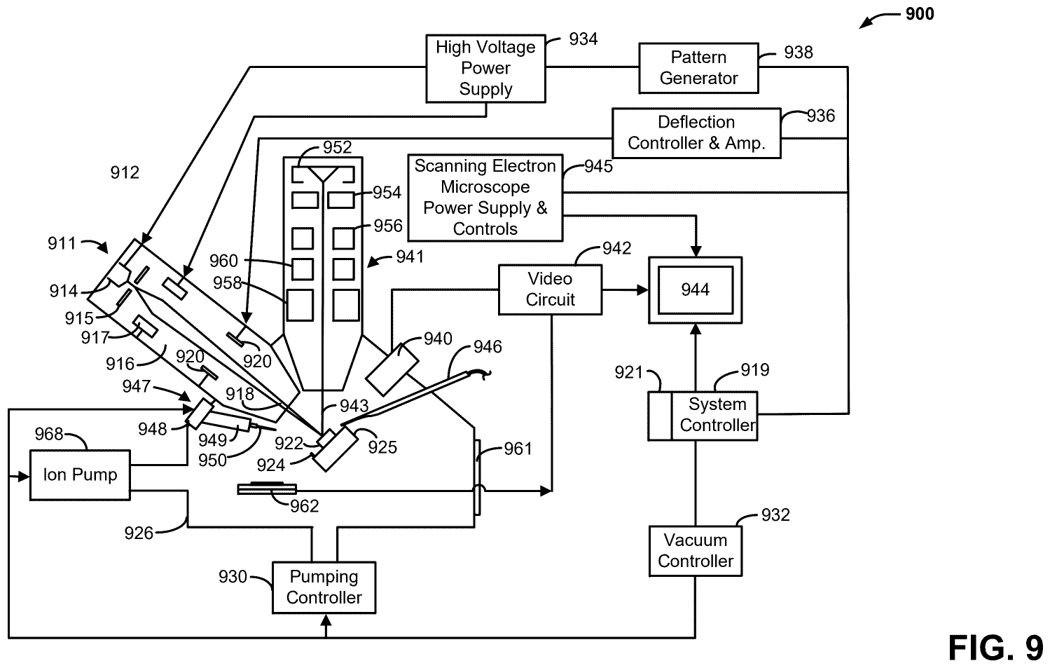

For example, control instructions 790 can comprise data and/or metadata in any suitable format comprising information directing an operation. That is, the control instructions 790, by the information, can be configured to generally modulate an operation of a source of charged particles or the sample holder of a scientific imaging system 732, such as the scientific imaging system 900 of FIG. 9, in response to being processed by the control circuity 814.

In one or more embodiments, the control instructions 790 can comprise endpointing instructions that are configured to modulate the operation of an FIB subsystem and an SEM subsystem to delayer a sample 734 and reveal one or more CMOS devices 838 of the sample 734.

In one or more embodiments, the control instructions 790 can comprise metrology information based at least in part on the image data 729 describing one or more CMOS devices 838, dynamic random-access memory (DRAM) devices 837, or NOT-AND (NAND) devices 839.

In one or more embodiments, the control instructions 790, and/or endpointing instructions, can comprise direction to generate a sample (e.g., a lamella) by a scientific imaging system (e.g., an FIB/SEM microscope), which sample can be employed by the scientific imaging system, or another scientific imaging system, comprising a TEM to generate one or more images of the sample.

In one or more embodiments, the analytical model 712 can be employed both to aid in generating the synthetic image data 740 and to generate the control instructions 790. Same and/or different training data (e.g., simulated training data, such as based on synthetic image data 740), can be employed to train a same analytical model 712 for both control instruction generation and synthetic image data generation, and/or to train different analytical models for one or both of control instruction generation or synthetic image data generation based.

In one or more embodiments, the synthetic image data 740 and control instructions 790 can correspond to a same set of operations relative to a same sample 734 to be operated upon at a scientific imaging system 732. In one or more embodiments, the synthetic image data 740 and control instructions 790 can correspond to different sets of operations relative to different samples 734 to be operated upon at a scientific imaging system 732.

In one or more embodiments, original image data 729 can be obtained from a same scientific imaging system 732 receiving and/or obtaining the control instructions 790. In one or more embodiments, original image data 729 can be obtained from a first scientific imaging system 732 and a second scientific imaging system 732, different from the first scientific imaging system 732, can receive and/or obtain the control instructions 790.

In one or more embodiments, base on input of computer-aided drafting (CAD) data (e.g., processed model input information 738) to a set of analytical models 712 comprising one or more analytical models 712 that are different from one another, and that have been trained to generate endpointing instructions (e.g., control instructions 790) based on the CAD input to the set of analytical models, the set of analytical models 712 can perform one or more operations. These operations can comprise generating, by the set of analytical models, endpointing instructions for a scientific imaging system comprising one or more of a focused ion beam (FIB) subsystem or a scanning electron microscope (SEM) subsystem. These operations can comprise, based on the CAD input and on the endpointing instructions, generating, by the set of analytical models 712, a set of synthetic images 742 of a sample 734 as a function of depth of imaging of the sample 734 (e.g., z-slices thereof). These operations can comprise, based on at least one synthetic image 742 of the set of synthetic images 742, generating, by the set of analytical models 712, additional synthetic image data 740 comprising template information describing a sequence of integrated circuit (IC) devices. These operations can comprise, based on the additional synthetic image data 740 and on the set of synthetic images 742, generating, by the set of analytical models 712, metrology information comprising a region of interest (ROI) specification for use with a sample to be imaged. This sample can be different from the sample 734. These operations can comprise, based on the metrology information, generating, by the by the set of analytical models 712, control instructions 790 for the scientific imaging system 732 comprising a transmission electron microscope (TEM) subsystem or another scientific imaging system 732. In one or more cases, the another scientific imaging system 732 can be different from the scientific imaging system 732 and/or can comprise a transmission electron microscope (TEM) subsystem.

Turning next briefly to FIG. 8, a scientific imaging system 732 is illustrated that can be controlled and/or operated using instructions 750 generated by the trained analytical model 712. That is, such instructions can be employed to identify a region of interest (ROI) 820, capture an image, identify a portion of a sample image of a sample 734 described by sample information 730, etc.

As illustrated, the scientific imaging system 732 can comprise a plurality of components, which are not limited to, control circuitry 814, logic circuits 876, a source of charged particles 810, machine-actuated sample holder 812, focused ion beam device (FIB) 870, scanning electron microscope (SEM) 872, and/or transmission electron microscope (TEM) 874.

Turning next briefly to FIG. 9, illustrated is an example dual beam system 900 for which instructions can provided by the outputting component 720 (e.g., instructions 750 for controlling operation of the dual beam system 900).

Discussion next turns to FIG. 7A and to description of the exemplary dual beam system 700 that can be employed as part of the non-limiting system 600. It is appreciated that in one or more embodiments, the dual beam system 700 can be employed in place of the dual beam system 501 and that description of the dual beam system 700 can also apply to the dual beam system 501.

FIG. 9 illustrates a typical beam system, such as a dual beam system 900, having an SEM column and a focused ion beam (FIB) column. While an example of suitable hardware is provided below, the embodiments described herein are not limited to being implemented in any particular type of hardware.

A scanning electron microscope (EM) 941, along with power supply and control unit 945, is provided with the dual beam system 900. An electron beam 943 is emitted from a cathode 952 by applying voltage between cathode 952 and an anode 954. Electron beam 943 is focused to a fine spot by means of a condensing lens 956 and an objective lens 958. Electron beam 943 is scanned two-dimensionally on the specimen by means of a deflection coil 960. Operation of condensing lens 956, objective lens 958, and deflection coil 960 is controlled by power supply and control unit 945.

The electron beam 943 can be focused onto a substrate 922, which is on movable X-Y stage 925 within lower chamber 926. When the electrons in the electron beam strike substrate 922, secondary charged particles are emitted. These secondary charged particles are detected by secondary electron detector 940 as discussed below. STEM detector 962, located beneath the TEM sample holder 924 and the stage 925, can collect electrons and/or ions that are transmitted through the sample mounted on the TEM sample holder as discussed above.

Dual beam system 900 also includes focused ion beam (FIB) system 911 which comprises an evacuated chamber having an upper neck portion 912 within which are located an ion source 914 and a focusing column 916 including extractor electrodes and an electrostatic optical system. The axis of focusing column 916 is tilted 52 degrees from the axis of the electron column. The neck portion, such as an ion column 912, can include an ion source 914, an extraction electrode 915, a focusing element 917, deflection elements 920, and/or a focused ion beam 918. Focused ion beam 918 passes from ion source 914 through focusing column 916 and between electrostatic deflection means schematically indicated at 920 toward substrate 922, which comprises, for example, a semiconductor device positioned on movable X-Y stage 925 within lower chamber 926.

Stage 925 can preferably move in a horizontal plane (X and Y axes) and vertically (Z axis). Stage 925 can also tilt approximately sixty (60) degrees and rotate about the Z axis. In some embodiments, a separate TEM sample stage (not shown) can be used. Such a TEM sample stage will also preferably be moveable in the X, Y, and Z axes. A door 961 is opened for inserting substrate 922 onto X-Y stage 925 and also for servicing an internal gas supply reservoir if one is used. The door is interlocked so that it cannot be opened if the system is under vacuum.

An ion pump 968 is employed for evacuating neck portion 912. The chamber 926 is evacuated with turbomolecular and mechanical pumping system 930 under the control of vacuum controller 932. The vacuum system provides within chamber 926 a vacuum of between approximately 1×10-7 Torr and 5×10-4 Torr. If an etch assisting, an etch retarding gas, or a deposition precursor gas is used, the chamber background pressure may rise, typically to about 1×10-5 Torr.

The high voltage power supply provides an appropriate acceleration voltage to electrodes in focusing column 916 for energizing and focusing ion beam 918. When it strikes substrate 922, material is sputtered, that is physically ejected, from the sample. Alternatively, ion beam 918 can decompose a precursor gas to deposit a material.

High voltage power supply 934 is connected to liquid metal ion source 914 as well as to appropriate electrodes in ion beam focusing column 916 for forming an approximately 1 keV to 60 keV ion beam 918 and directing the same toward a sample. Deflection controller and amplifier 936, operated in accordance with a prescribed pattern provided by pattern generator 938, is coupled to deflection plates 920 whereby ion beam 918 may be controlled manually or automatically to trace out a corresponding pattern on the upper surface of substrate 922. In some systems the deflection plates are placed before the final lens, as is well known in the art. Beam blanking electrodes (not shown) within ion beam focusing column 916 cause ion beam 918 to impact onto blanking aperture (not shown) instead of substrate 922 when a blanking controller (not shown) applies a blanking voltage to the blanking electrode.

The liquid metal ion source 914 typically provides a metal ion beam of gallium. The source typically is capable of being focused into a sub one-tenth micrometer wide beam at substrate 922 for either modifying the substrate 922 by ion milling, enhanced etch, material deposition, or for the purpose of imaging the substrate 922.

A charged particle detector 940, such as an Everhart Thornley or multi-channel plate, used for detecting secondary ion or electron emission is connected to a video circuit 942 that supplies drive signals to video monitor 944 and receiving deflection signals from a system controller 919. The location of charged particle detector 940 within lower chamber 926 can vary in different embodiments. For example, a charged particle detector 940 can be coaxial with the ion beam and include a hole for allowing the ion beam to pass. In other embodiments, secondary particles can be collected through a final lens of the SEM and then diverted off axis for collection.

A micromanipulator 947 can precisely move objects within the vacuum chamber. Micromanipulator 947 may comprise precision electric motors 948 positioned outside the vacuum chamber to provide X, Y, Z, and theta control of a portion 949 positioned within the vacuum chamber. The micromanipulator 947 can be fitted with different end effectors for manipulating small objects. In the embodiments described herein, the end effector is a thin probe 950.

A gas delivery system 946 extends into lower chamber 926 for introducing and directing a gaseous vapor toward substrate 922. For example, iodine can be delivered to enhance etching, or a metal organic compound can be delivered to deposit a metal.

System controller 919 controls the operations of the various parts of dual beam system 900. Through system controller 919, a user can cause ion beam 918 or electron beam 943 to be scanned in a desired manner through commands entered into a conventional user interface (not shown). Alternatively, system controller 919 may control dual beam system 900 in accordance with programmed instructions stored in a memory 921. In some embodiments, dual beam system 900 incorporates image recognition software to automatically identify regions of interest, and then the system can manually or automatically extract samples in accordance with the present application. For example, the system could automatically locate similar features on semiconductor wafers including multiple devices and take samples of those features on different (or the same) devices.

Turning again back to FIGS. 7 and 8, and also now referring to FIG. 4 again, the instructions 750 can comprise direction for identifying a region of interest 820 of a sample 734, as noted above. For example, the analytical model 712 can perform and/or send instructions 750 directing one or more logic circuits 876 of the scientific imaging system 732 to identify, a first set of groupings (e.g., clusters 410-1, 410-2, 410-3), of the groupings of IC devices, and subsequently identifying a specified grouping (e.g., cluster 410-1, for example), of the first set of groupings, based on a first identification of one of the following aspects and a second identification of the other of the following aspects: a number of IC devices respectively comprised by a grouping of the groupings of IC devices, or a shape-based feature, or other physical feature, (e.g., feature 415-1, 415-2) of at least one IC device of a grouping of the groupings of IC devices.

As another example, the instructions 750 can comprise direction for generating image data of a sample disposed in the sample holder, inputting a portion of the image data (e.g., sample information 730) to the analytical model 712 that is trained on a dataset of synthetic image data 740 describing synthetic images 742 corresponding to the image data of the sample 734, and/or generating, by the analytical model 712, the control instructions 750 configured to modulate an operation of the source of charged particles 810 or the sample holder 812 in response to being processed by the control circuity 814.

In one or more embodiments, such as illustrated at FIG. 9, the scientific imaging system 732 can comprise a focused ion beam (FIB) subsystem and a scanning electron microscope (SEM) subsystem. In connection therewith, the sample 734 can comprise one or more complementary metal-oxide semiconductor (CMOS) devices 838, dynamic random-access memory (DRAM) devices 837, and/or NOT-AND (NAND) devices 839, and the control instructions 750 can comprise end-pointing instructions configured to modulate the operation of the FIB subsystem and the SEM subsystem to delayer the sample 734 and reveal the one or more CMOS devices 838.

In one or more embodiments, the scientific imaging system 732 can comprise a transmission electron microscope (TEM) system. In connection therewith, the sample can comprise one or more complementary metal-oxide semiconductor (CMOS) devices, 838, dynamic random-access memory (DRAM) devices 837, and/or NOT-AND (NAND) devices 839, and the control instructions 740 can comprise metrology information (e.g., sample information 730) based at least in part on the image data 729 describing the one or more CMOS devices 838, dynamic random-access memory (DRAM) devices 837, and/or NOT-AND (NAND) devices 839.

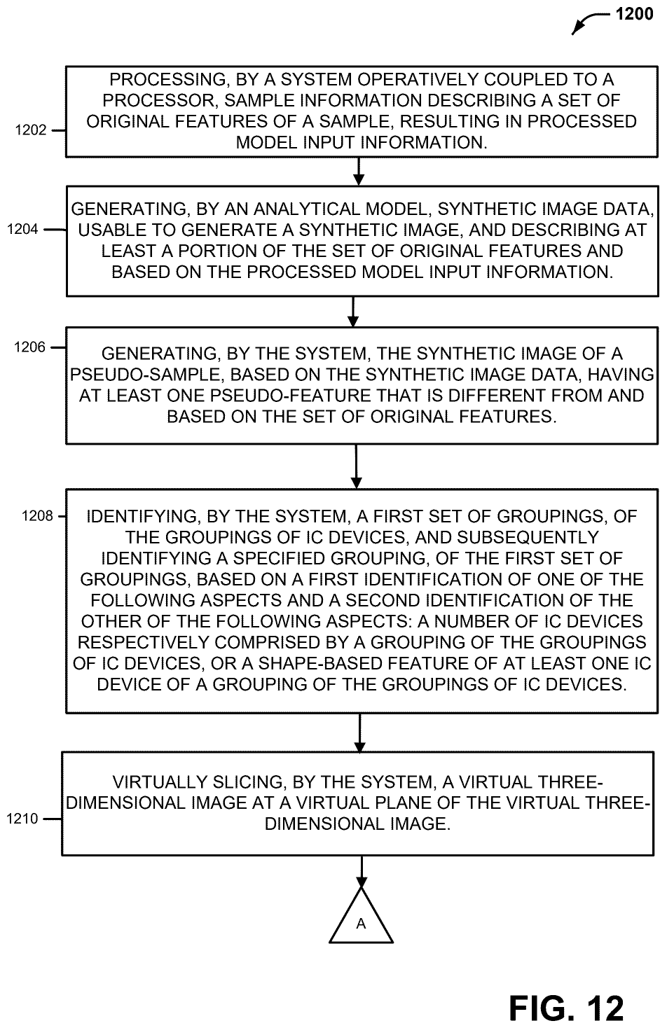

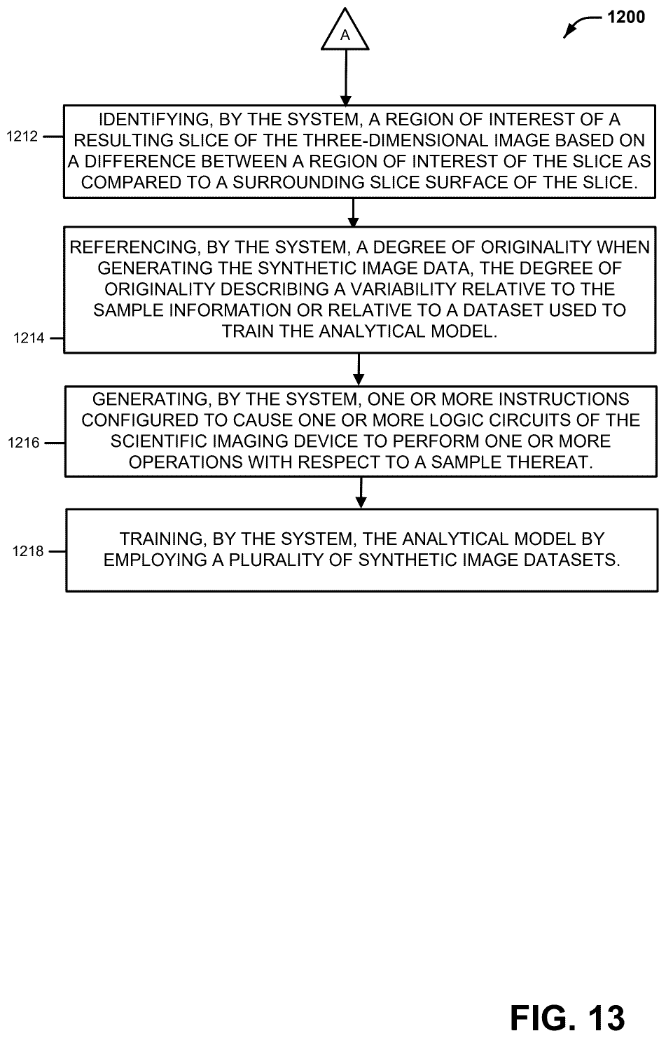

As a summary of the above-described components and/or functions thereof, referring next to FIGS. 12 and 13, illustrated is a flow diagram of an example, non-limiting method 1200 that can facilitate a process for measurement device output comparison and/or evaluation, in accordance with one or more example embodiments described herein, such as the non-limiting system 700 of FIG. 7. While the non-limiting method 1200 is described relative to the non-limiting system 700 of FIG. 7, the non-limiting method 1200 can be applicable also to other systems described herein, such as the non-limiting system 800 of FIG. 8. Repetitive description of like elements and/or processes employed in respective embodiments is omitted for sake of brevity.

At 1202, the non-limiting method 1200 can comprise processing, by a system operatively coupled to a processor (e.g., processor 706) (e.g., information processing component 710), sample information (e.g., sample information 730) describing a set of original features (e.g., original features 736) of a sample (e.g., sample 734), resulting in processed model input information (e.g., processed model input information 738).

At 1204, the non-limiting method 1200 can comprise generating, by an analytical model (e.g., analytical model 712 and optionally using the data generating component 716), synthetic image data (e.g., synthetic image data 740), usable to generate a synthetic image (e.g., synthetic image 742), and describing at least a portion of the set of original features and based on the processed model input information.

At 1206, the non-limiting method 1200 can comprise generating, by the system (e.g., image generating component 718), the synthetic image (e.g., synthetic image 742) of a pseudo-sample (e.g., pseudo-sample 744), based on the synthetic image data, having at least one pseudo-feature (e.g., pseudo-feature 746) that is different from and based on the set of original features.

At 1208, the non-limiting method 1200 can comprise identifying, by the system (e.g., analytical model 712), a first set of groupings (e.g., groupings 410), of the groupings of IC devices (e.g., IC devices 830), and subsequently identifying a specified grouping, of the first set of groupings, based on a first identification of one of the following aspects and a second identification of the other of the following aspects: a number of IC devices respectively comprised by a grouping of the groupings of IC devices, or a shape-based feature of at least one IC device of a grouping of the groupings of IC devices.

At 1210, the non-limiting method 1200 can comprise virtually slicing, by the system (e.g., analytical model 712 and/or scientific imaging system 732) a virtual three-dimensional image (e.g., virtual 3D image 842) at a virtual plane (e.g., virtual plane 1008) of the virtual three-dimensional image.

At 1212, the non-limiting method 1200 can comprise identifying by the system (e.g., analytical model 712), a region of interest (e.g., ROI 820) of a resulting slice of the virtual three-dimensional image based on a difference between a region of interest of the slice as compared to a surrounding slice surface (e.g., slice surface 1006) of the slice.

At 1214, the non-limiting method 1200 can comprise referencing, by the system (e.g., analytical model 712 and/or data generating component 716), a degree of originality (e.g., degree of originality 748) when generating the synthetic image data, the degree of originality describing a variability relative to the sample information or relative to a dataset used to train the analytical model.

At 1216, the non-limiting method 1200 can comprise generating, by the system, one or more instructions (e.g., instructions 750) configured to cause one or more logic circuits (e.g., logic circuits 876) of the scientific imaging device to perform one or more operations with respect to a sample thereat.

At 1218, the non-limiting method 1200 can comprise training, by the system, the analytical model by employing a plurality of synthetic image datasets.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, one or more systems, computer program products and/or computer-implemented methods provided herein and/or described herein relate to synthetic image data generation and use. A computer-implemented method can comprise for generating synthetic data describing a sample can comprise processing, by a system operatively coupled to a processor, sample information describing a set of original features of a sample, resulting in processed model input information, and generating, by an analytical model, synthetic image data, usable to generate a synthetic image, and describing at least a portion of the set of original features and based on the processed model input information. The computer-implemented method further can comprise generating, by the system, the synthetic image of a pseudo-sample, based on the synthetic image data, having at least one pseudo-feature that is different from and based on the set of original features.

The one or more example embodiments described herein can be implemented within, in connection with and/or coupled to an imaging device, imaging system, scientific measurement device, and/or scientific measurement system.

Indeed, in view of the one or more example embodiments described herein, a practical application of the one or more systems, computer-implemented methods and/or computer program products described herein can be an ability to generate synthetic sample data for training an analytical model, train the analytical model on the synthetic sample data, and/or employ the analytical model for sample preparation, sample imaging, and/or control of an imaging and/or scientific measurement device and/or system. These are useful and practical applications of computers, thus providing enhanced (e.g., improved and/or optimized) analytical model training, sample preparation and/or imaging system use. Overall, such computerized tools can constitute a concrete and tangible technical improvement in the fields of material analysis, and more particularly in employing scientific imaging systems, such as including, but not limited to, the field of electron microscopy.

Furthermore, one or more example embodiments described herein can be employed in a real-world system based on the disclosed teachings. For example, the one or more example embodiments described herein can generate synthetic sample data and/or train an analytical model without preparing, fabricating and/or obtaining dozens, hundreds, or even thousands of samples, as is the case in existing frameworks. This can save power, bandwidth, device/system use time, user entity time, cost, etc. These can be useful processes for varying industries employing material analysis, product manufacturing and/or fabrication, quality control and/or the like. The embodiments disclosed herein thus can provide improvements to scientific instrument technology (e.g., improvements in the computer technology supporting such scientific instruments, among other improvements).

Moreover, the one or more example embodiments described herein can achieve a level of scale of operation. For example, sample information corresponding to two or more samples can be processed and employed for training at least partially in parallel with one another. Additionally, and/or alternatively, synthetic image data corresponding to two or more operations can be employed at least partially in parallel with one another to operate one or more scientific imaging systems.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more example embodiments described herein can be, in one or more example embodiments, inherently and/or inextricably tied to computer technology and cannot be implemented outside of a computing environment. For example, one or more processes performed by one or more example embodiments described herein can more efficiently, and even more feasibly, provide program and/or program instruction execution, such as relative to generation of synthetic sample data, as compared to existing systems and/or techniques. Systems, computer-implemented methods and/or computer program products providing performance of these processes are of great utility in the fields of material analysis and cannot be equally practicably implemented in a sensible way outside of a computing environment.

One or more example embodiments described herein can employ hardware and/or software to solve problems that are highly technical, that are not abstract, and that cannot be performed as a set of mental acts by a human. For example, a human, or even thousands of humans, cannot efficiently, accurately and/or effectively analyze computer data/metadata (e.g., synthetic image data and/or sample information data) describing original sample images, CAD images, synthetic images and/or the like, as the one or more example embodiments described herein can provide this process. Moreover, neither can the human mind nor a human with pen and paper conduct one or more of these processes, as conducted by one or more example embodiments described herein.

In one or more example embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more example embodiments described herein and/or components thereof can be employed to solve new problems that arise through advancements in technologies mentioned above, employment of quantum computing systems, cloud computing systems, computer architecture and/or another technology.

One or more example embodiments described herein can be fully operational towards performing one or more other functions (e.g., fully powered on, fully executed and/or another function) while also performing one or more of the one or more operations described herein.

To provide additional summary, a listing of embodiments and features thereof is next provided.

A computer-implemented method for generating synthetic data describing a sample can comprise processing, by a system operatively coupled to a processor, sample information describing a set of original features of a sample, resulting in processed model input information; and generating, by an analytical model, synthetic image data, usable to generate a synthetic image, and describing at least a portion of the set of original features and based on the processed model input information.

The computer-implemented method of the preceding paragraph, further comprising: generating, by the system, a synthetic image of a pseudo-sample, based on the synthetic image data, having at least one pseudo-feature that is different from and based on the set of original features.

The computer-implemented method of any preceding paragraph, wherein the sample information comprises image data describing an integrated circuit (IC), wherein the set of original features comprises one or more IC devices of the integrated circuit, and wherein the synthetic image data comprises one or more physical characteristics of the one or more IC devices.

The computer-implemented method of any preceding paragraph, wherein the sample information comprises computer-aided drafting (CAD) data describing the set of original features and associated noise data in an image format.

The computer-implemented method of any preceding paragraph, wherein the sample information comprises graphic data system formatted data (GDS or GDSII) or open artwork system interchange standard formatted data (OASIS).

The computer-implemented method of any preceding paragraph, wherein the sample information and the synthetic image data each describe a region of interest described in reference to computer-aided drafting (CAD) data describing only a portion of the sample.

The computer-implemented method of any preceding paragraph, wherein the processed model input information describes a sequence of integrated circuit (IC) devices comprising one or more groupings of the IC devices arranged relative to one another by specified relationships among features of the IC devices.

The computer-implemented method of any preceding paragraph, further comprising: identifying, by the system, a first set of groupings, of the groupings of IC devices, and subsequently identifying a specified grouping, of the first set of groupings, based on a first identification of one of the following aspects and a second identification of the other of the following aspects: a number of IC devices respectively comprised by a grouping of the groupings of IC devices, or a shape-based feature of at least one IC device of a grouping of the groupings of IC devices.

The computer-implemented method of any preceding paragraph, wherein the synthetic image comprises a synthetic transmission electron microscope (TEM) image defined by the synthetic image data.

The computer-implemented method of any preceding paragraph, wherein the synthetic image comprises a virtual three-dimensional image, and wherein the computer-implemented method further comprises: virtually slicing the virtual three-dimensional image at a virtual plane of the virtual three-dimensional image; and identifying a region of interest of a resulting slice of the three-dimensional image based on a difference between a region of interest of the slice as compared to a surrounding slice surface of the slice.

The computer-implemented method of any preceding paragraph, wherein the analytical model comprises an adversarial component, a generative adversarial network (GAN), a diffusion model, a neural network model, or a convolutional neural network model that is trained using a training dataset of synthetically-generated images of integrated circuit devices, lamellae cut faces or transmission electron microscope workflow images.

The computer-implemented method of any preceding paragraph, wherein the analytical model is further configured to reference a degree of originality when generating the synthetic image data, the degree of originality describing a variability relative to the sample information or relative to a dataset used to train the analytical model.

One or more systems of machines, comprising one or more logic circuits and one or more computer-readable storage media storing instructions that, when executed by the one or more systems of machines, cause the one or more logic circuits to perform one or more operations of the computer-implemented method of any preceding paragraph.

The computer-implemented method of any preceding paragraph, further comprising: inputting, by the system, computer-aided drafting (CAD) data to a set of analytical models comprising the analytical model and additional analytical models different from the analytical model, that have been trained to generate endpointing instructions based on the CAD input to the set of analytical models; generating, by the set of analytical models, endpointing instructions for a scientific imaging system comprising one or more of a focused ion beam (FIB) subsystem or a scanning electron microscope (SEM) subsystem; generating, by the set of analytical models, additional synthetic image data comprising template information describing a sequence of integrated circuit (IC) devices; based on the additional synthetic image data and on the set of synthetic images, generating, by the set of analytical models, metrology information comprising a region of interest (ROI) specification for use with a sample to be imaged; and based on the metrology information, generating, by the by the set of analytical models, control instructions for the scientific imaging system comprising a transmission electron microscope (TEM) subsystem or another scientific imaging system.

The computer-implemented method of any preceding paragraph, further comprising: inputting, by the system, computer-aided drafting (CAD) data to a set of analytical models comprising the analytical model and additional analytical models different from the analytical model, that have been trained to generate endpointing instructions based on the CAD input to the set of analytical models; generating, by the set of analytical models, endpointing instructions for a scientific imaging system comprising one or more of a focused ion beam (FIB) subsystem or a scanning electron microscope (SEM) subsystem; based on the CAD input and on the endpointing instructions, generating, by the set of analytical models, a set of synthetic images, comprising the synthetic image, of the sample as a function of depth of imaging of the sample; based on at least one synthetic image of the set of synthetic images, generating, by the set of analytical models, additional synthetic image data comprising template information describing a sequence of integrated circuit (IC) devices; based on the additional synthetic image data and on the set of synthetic images, generating, by the set of analytical models, metrology information comprising a region of interest (ROI) specification for use with a sample to be imaged; and based on the metrology information, generating, by the by the set of analytical models, control instructions for the scientific imaging system comprising a transmission electron microscope (TEM) subsystem or another scientific imaging system.

The computer-implemented method of any preceding paragraph, wherein the synthetic image data describes a sequence of integrated circuit (IC) devices comprising one or more groupings of the IC devices arranged relative to one another by specified relationships among features of the IC devices.

The computer-implemented method of any preceding paragraph, further comprising: identifying, by the system, a first set of groupings, of the groupings of IC devices of the synthetic image, based on the synthetic image data, and subsequently identifying a specified grouping, of the first set of groupings, based on a first identification of one of the following aspects and a second identification of the other of the following aspects: a number of IC devices respectively comprised by a grouping of the groupings of IC devices, or a shape-based feature of at least one IC device of a grouping of the groupings of IC devices.

The computer-implemented method of any preceding paragraph, further comprising: identifying, by the system, a first set of groupings, of the groupings of IC devices of the synthetic image and subsequently identifying a specified grouping, of the first set of groupings, based on a first identification of one of the following aspects and a second identification of the other of the following aspects: a number of IC devices respectively comprised by a grouping of the groupings of IC devices, or a shape-based feature of at least one IC device of a grouping of the groupings of IC devices.

The computer-implemented method of any preceding paragraph, wherein the analytical model comprises an adversarial component, a diffusion model, a neural network model, or a convolutional neural network model that is trained using a training dataset of synthetically-generated images of integrated circuit devices, lamellae cut faces or transmission electron microscope workflow images.

A charged particle beam system, can comprise a source of charged particles, a machine-actuated sample holder, and control circuitry operatively coupled to: a memory that stores computer executable components; and a processor that executes the computer executable components stored in the memory to cause the processor to perform operations comprising: generating image data of a sample disposed in the sample holder; inputting a portion of the image data to an analytical model that is trained on a dataset of synthetic image data describing synthetic images corresponding to the image data of the sample; and generating, by the analytical model, control instructions configured to modulate an operation of the source of charged particles or the sample holder in response to being processed by the control circuity.

The charged particle beam system of the preceding paragraph, further comprising: a focused ion beam (FIB) subsystem; and a scanning electron microscope (SEM) subsystem, wherein the sample comprises one or more complementary metal-oxide semiconductor (CMOS) devices, dynamic random-access memory (DRAM) devices, or NOT-AND (NAND) devices, and wherein control instructions comprise endpointing instructions configured to modulate the operation of the FIB subsystem and the SEM subsystem to delayer the sample and reveal the one or more CMOS devices.

The charged particle beam system of any preceding paragraph, further comprising: a transmission electron microscope (TEM) system, wherein the sample comprises one or more complementary metal-oxide semiconductor (CMOS) devices, dynamic random-access memory (DRAM) devices, or NOT-AND (NAND) devices, and wherein the control instructions comprise metrology information based at least in part on the image data describing the one or more CMOS devices.

A computer program product facilitating a process for imaging device endpointing, the computer program product can comprise a computer readable storage medium having program instructions embodied therewith, the program instructions executable by a processor to cause the processor to: process, by the processor, sample information describing a set of original features of a sample, resulting in processed model input information; and generate, by the processor, synthetic image data, usable to generate a synthetic image, and describing at least a portion of the set of original features and based on the processed model input information.

The computer program product of computer program product of any preceding paragraph, wherein the program instructions are further executable by the processor to cause the processor to: generate, by the processor, the synthetic image of a pseudo-sample, based on the synthetic image data, having at least one pseudo-feature that is different from and based on the set of original features.

The computer program product of computer program product of any preceding paragraph, wherein the synthetic image comprises a virtual three-dimensional image, and wherein the program instructions are further executable by the processor to cause the processor to: virtually slice, by the processor, the virtual three-dimensional image at a virtual plane of the virtual three-dimensional image; and identify, by the processor, a region of interest of a resulting slice of the three-dimensional image based on a difference between a region of interest of the slice as compared to a surrounding slice surface of the slice.

The computer program product of computer program product of any preceding paragraph, wherein the sample information comprises image data describing an integrated circuit (IC), wherein the set of original features comprises one or more IC devices of the integrated circuit, and wherein the synthetic image data comprises one or more physical characteristics of the one or more IC devices.

A computer-implemented method can comprise: receiving microscope image data; detecting a feature in the microscope image data; receiving feature template data describing a grouping of features including the feature; detecting the grouping in the microscope image data based at least in part on the feature template data; generating template information describing the grouping; and outputting the template information.

The computer-implemented method of the preceding paragraph, wherein detecting the feature in the microscope image data comprises: inputting at least a portion of the microscope image data to a model configured to detect the feature; and generating, as an output of the model, coordinate information describing a location of the feature in the microscope image data.

The computer-implemented method of any preceding paragraph, wherein the location of the feature corresponds to a set of coordinates for a centroid of the feature.

The computer-implemented method of any preceding paragraph, wherein the model comprises a convolutional neural network trained to input the portion of the microscope image data and to output the coordinate information.

The computer-implemented method of any preceding paragraph, wherein the feature is a first feature, the model is a first model, the portion is a first portion, the coordinate information is first coordinate information, and the location is a first location, and wherein the microscope image data includes a second feature, the method further comprising: inputting at least a second portion of the microscope image data to a second model configured to detect the second feature; and generating, as an output of the second model, second coordinate information describing a second location of the second feature in the microscope image data.

The computer-implemented method of any preceding paragraph, wherein the feature is a first feature, wherein the feature template data describes a sequence of multiple features including the first feature, and wherein detecting the grouping comprises: convolving the feature template data with the coordinate information; and detecting an instance of the grouping in the microscope image data based at least in part on the location of the feature relative to at least a subset of the multiple features in the sequence.

The computer-implemented method of any preceding paragraph, wherein the detecting the instance of the grouping comprises: determining a first rank of the first feature in the sequence; and determining that the first rank of the first feature and a second rank of a second feature in the sequence match the feature template data.

The computer-implemented method of any preceding paragraph, wherein the feature template data comprises feature multiplicity information and feature order information.

The computer-implemented method of any preceding paragraph, wherein detecting the grouping in the image data comprises detecting an instance of the grouping having an inverse feature order.

The computer-implemented method of any preceding paragraph, wherein the feature forms at least part of a device in an integrated circuit.

The computer-implemented method of any preceding paragraph, wherein the microscope image data comprises an image generated by a charged particle microscope.

The computer-implemented method of any preceding paragraph, wherein the microscope image data further comprises coordinate metadata mapping a pixel of the image data to a position on a sample.

The computer-implemented method of any preceding paragraph, wherein outputting the template information comprises sending the template information to a charged particle microscope, the charged particle microscope being configured to generate image data based at least in part on the template information.

The computer-implemented method of any preceding paragraph, wherein the template information comprises a location of the grouping in the microscope image data.

The computer-implemented method of any preceding paragraph, wherein the location of the grouping corresponds to a vertex of a bounding box circumscribing the grouping.

One or more non-transitory machine-readable media, storing instructions that, when executed by a machine, cause the machine to perform operations comprising: receiving microscope image data; detecting a feature in the microscope image data; receiving feature template data describing a grouping of features including the feature; detecting the grouping in the microscope image data based at least in part on the feature template data; generating template information describing the grouping; and outputting the template information.

The media of the preceding paragraph, wherein detecting the feature in the microscope image data comprises: inputting at least a portion of the microscope image data to a model configured to detect the feature; and generating, as an output of the model, coordinate information describing a location of the feature in the microscope image data.

The media of any preceding paragraph, wherein the feature is a first feature, the model is a first model, the portion is a first portion, the coordinate information is first coordinate information, and the location is a first location, and wherein the microscope image data includes a second feature, the operations further comprising: inputting at least a second portion of the microscope image data to a second model configured to detect the second feature; and generating, as an output of the second model, second coordinate information describing a second location of the second feature in the microscope image data.

The media of any preceding paragraph, wherein outputting the template information comprises sending the template information to a charged particle microscope, the charged particle microscope being configured to generate image data based at least in part on the template information.

The media of any preceding paragraph, wherein the feature is a first feature, wherein the feature template data describes a sequence of multiple features including the first feature, and wherein detecting the grouping comprises: convolving the feature template data with the coordinate information; and detecting an instance of the grouping in the microscope image data based at least in part on the location of the feature relative to at least a subset of the multiple features in the sequence.

### Example Operating Environment

FIG. 14 is a schematic block diagram of an operating environment 1400 with which the described subject matter can interact. The operating environment 1400 comprises one or more remote component(s) 1410. The remote component(s) 1410 can be hardware and/or software (e.g., threads, processes, computing devices). In one or more example embodiments, remote component(s) 1410 can be a distributed computer system, connected to a local automatic scaling component and/or programs that use the resources of a distributed computer system, via communication framework 1440. Communication framework 1440 can comprise wired network devices, wireless network devices, mobile devices, wearable devices, radio access network devices, gateway devices, femtocell devices, servers, etc.

The operating environment 1400 also comprises one or more local component(s) 1420. The local component(s) 1420 can be hardware and/or software (e.g., threads, processes, computing devices). In one or more example embodiments, local component(s) 1420 can comprise an automatic scaling component and/or programs that communicate/use the remote resources 1410 and 1420, etc., connected to a remotely located distributed computing system via communication framework 1440.

One possible communication between a remote component(s) 1410 and a local component(s) 1420 can be in the form of a data packet adapted to be transmitted between two or more computer processes. Another possible communication between a remote component(s) 1410 and a local component(s) 1420 can be in the form of circuit-switched data adapted to be transmitted between two or more computer processes in radio time slots. The operating environment 1400 comprises a communication framework 1440 that can be employed to facilitate communications between the remote component(s) 1410 and the local component(s) 1420, and can comprise an air interface, e.g., interface of a UMTS network, via an LTE network, etc. Remote component(s) 1410 can be operably connected to one or more remote data store(s) 1450, such as a hard drive, solid state drive, subscriber identity module (SIM) card, electronic SIM (eSIM), device memory, etc., that can be employed to store information on the remote component(s) 1410 side of communication framework 1440. Similarly, local component(s) 1420 can be operably connected to one or more local data store(s) 1430, that can be employed to store information on the local component(s) 1420 side of communication framework 1440.

### Example Computing Environment

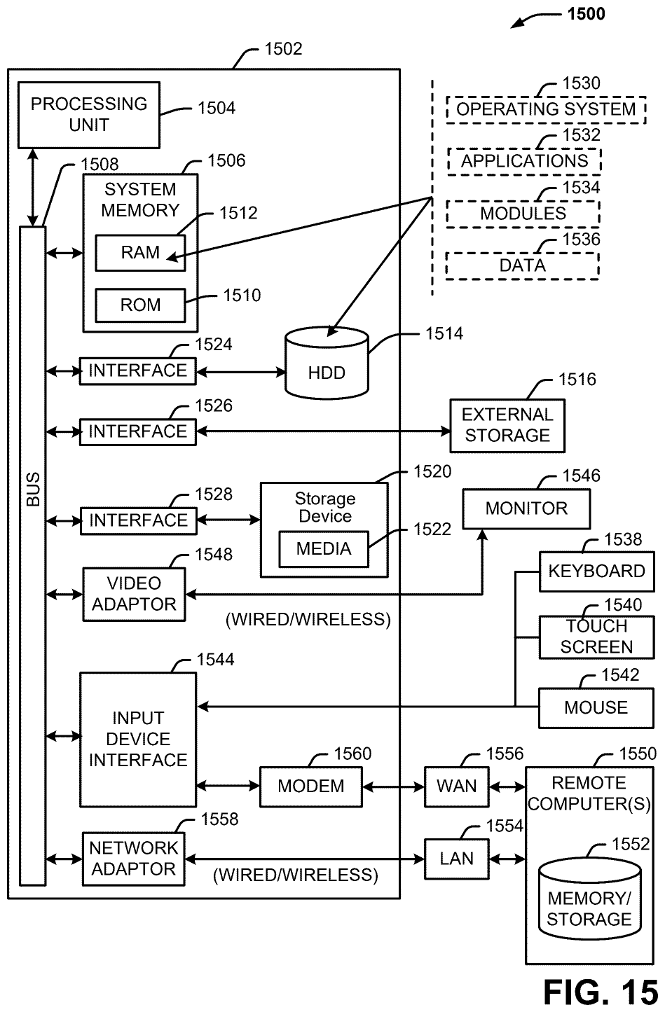

In order to provide additional context for various embodiments described herein, FIG. 15 and the following discussion are intended to provide a brief, general description of a suitable computing environment 1500 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform tasks or implement abstract data types. Moreover, the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Referring still to FIG. 15, the example computing environment 1500 which can implement one or more example embodiments described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a non-volatile memory such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), and can include one or more external storage devices 1516 (e.g., a magnetic floppy disk drive (FDD) 1516, a memory stick or flash drive reader, a memory card reader, etc.). While the internal HDD 1514 is illustrated as located within the computer 1502, the internal HDD 1514 can also be configured for external use in a suitable chassis (not shown). Additionally, while not shown in computing environment 1500, a solid-state drive (SSD) could be used in addition to, or in place of, an HDD 1514.

Other internal or external storage can include at least one other storage device 1520 with storage media 1522 (e.g., a solid-state storage device, a nonvolatile memory device, and/or an optical disk drive that can read or write from removable media such as a CD-ROM disc, a DVD, a BD, etc.). The external storage 1516 can be facilitated by a network virtual machine. The HDD 1514, external storage device 1516 and storage device (e.g., drive) 1520 can be connected to the system bus 1508 by an HDD interface 1524, an external storage interface 1526 and a drive interface 1528, respectively.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the .NET framework, for applications 1532. Runtime environments are consistent execution environments that allow applications 1532 to run on any operating system that includes the runtime environment. Similarly, operating system 1530 can support containers, and applications 1532 can be in the form of containers, which are lightweight, standalone, executable packages of software that include, e.g., code, runtime, system tools, system libraries and settings for an application.

Further, computer 1502 can be enabled with a security module, such as a trusted processing module (TPM). For instance, with a TPM, boot components hash next in time boot components and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user entity can enter commands and information into the computer 1502 through one or more wired/wireless input devices, e.g., a keyboard 1538, a touch screen 1540, and a pointing device, such as a mouse 1542. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera, a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1394 serial port, a game port, a USB port, an IR interface, a BLUETOOTH® interface, etc.

A monitor 1546 or other type of display device can also be connected to the system bus 1508 via an interface, such as a video adapter 1548. In addition to the monitor 1546, a computer typically includes other peripheral output devices (not shown), such as speakers, printers, etc.

The computer 1502 can operate in a networked environment using logical connections via wired and/or wireless communications to one or more remote computers, such as a remote computer 1550. The remote computer 1550 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1552 is illustrated. The logical connections depicted include wired/wireless connectivity to a local area network (LAN) 1554 and/or larger networks, e.g., a wide area network (WAN) 1556. Such LAN and WAN networking environments are commonplace in offices and companies, and facilitate enterprise-wide computer networks, such as intranets, all of which can connect to a global communications network, e.g., the Internet.

When used in a LAN networking environment, the computer 1502 can be connected to the local network 1554 through a wired and/or wireless communication network interface or adapter 1558. The adapter 1558 can facilitate wired or wireless communication to the LAN 1554, which can also include a wireless access point (AP) disposed thereon for communicating with the adapter 1558 in a wireless mode.

When used in a WAN networking environment, the computer 1502 can include a modem 1560 or can be connected to a communications server on the WAN 1556 via other means for establishing communications over the WAN 1556, such as by way of the Internet. The modem 1560, which can be internal or external and a wired or wireless device, can be connected to the system bus 1508 via the input device interface 1544. In a networked environment, program modules depicted relative to the computer 1502 or portions thereof, can be stored in the remote memory/storage device 1552. The network connections shown are example and other means of establishing a communications link between the computers can be used.

When used in either a LAN or WAN networking environment, the computer 1502 can access cloud storage systems or other network-based storage systems in addition to, or in place of, external storage devices 1516 as described above. Generally, a connection between the computer 1502 and a cloud storage system can be established over a LAN 1554 or WAN 1556 e.g., by the adapter 1558 or modem 1560, respectively. Upon connecting the computer 1502 to an associated cloud storage system, the external storage interface 1526 can, with the aid of the adapter 1558 and/or modem 1560, manage storage provided by the cloud storage system as it would other types of external storage. For instance, the external storage interface 1526 can be configured to provide access to cloud storage sources as if those sources were physically connected to the computer 1502.

The computer 1502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a defined structure as with an existing network or simply an ad hoc communication between at least two devices.

### Additional Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more example embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more example embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more example embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more example embodiments described herein.

Aspects of the one or more example embodiments described herein are described with reference to flowchart illustrations and/or block diagrams of methods, apparatus (systems), and computer program products according to one or more example embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more example embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more example embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more example embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or. ” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more example embodiments, but one of ordinary skill in the art can recognize that many further combinations and/or permutations of the one or more example embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments can use the phrases “an embodiment,” “various embodiments,” “one or more example embodiments” and/or “some embodiments,” each of which can refer to one or more of the same or different embodiments.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A computer-implemented method for generating synthetic data describing a sample, the method comprising:
processing, by a system operatively coupled to a processor, sample information describing a set of original features of a sample, resulting in processed model input information; and
generating, by an analytical model, synthetic image data, usable to generate a synthetic image, and describing at least a portion of the set of original features and based on the processed model input information.

2. The computer-implemented method of claim 1, further comprising:
generating, by the system, the synthetic image of a pseudo-sample, based on the synthetic image data, having at least one pseudo-feature that is different from and based on the set of original features.

3. The computer-implemented method of claim 1, wherein the sample information comprises image data describing an integrated circuit (IC), wherein the set of original features comprises one or more IC devices of the integrated circuit, and wherein the synthetic image data comprises one or more physical characteristics of the one or more IC devices.

4. The computer-implemented method of claim 1, wherein the sample information comprises computer-aided drafting (CAD) data describing the set of original features and associated noise data in an image format.

5. The computer-implemented method of claim 1, wherein the sample information comprises graphic data system formatted data (GDS or GDSII) or open artwork system interchange standard formatted data (OASIS).

6. The computer-implemented method of claim 1, wherein the sample information and the synthetic image data each describe a region of interest described in reference to computer-aided drafting (CAD) data describing only a portion of the sample.

7. The computer-implemented method of claim 4, wherein the synthetic image data describes a sequence of integrated circuit (IC) devices comprising one or more groupings of the IC devices arranged relative to one another by specified relationships among features of the IC devices.

8. The computer-implemented method of claim 7, further comprising:
identifying, by the system, a first set of groupings, of the groupings of IC devices of the synthetic image, and subsequently identifying a specified grouping, of the first set of groupings, based on a first identification of one of the following aspects and a second identification of the other of the following aspects:
a number of IC devices respectively comprised by a grouping of the groupings of IC devices, or
a shape-based feature of at least one IC device of a grouping of the groupings of IC devices.

9. The computer-implemented method of claim 7, further comprising:
identifying, by the system, a first set of groupings, of the groupings of IC devices of the synthetic image, based on the synthetic image data, and subsequently identifying a specified grouping, of the first set of groupings, based on a first identification of one of the following aspects and a second identification of the other of the following aspects:
a number of IC devices respectively comprised by a grouping of the groupings of IC devices, or
a shape-based feature of at least one IC device of a grouping of the groupings of IC devices.

10. The computer-implemented method of claim 2, wherein the synthetic image comprises a synthetic transmission electron microscope (TEM) image defined by the synthetic image data.

11. The computer-implemented method of claim 2, wherein the synthetic image comprises a virtual three-dimensional image, and wherein the computer-implemented method further comprises:
virtually slicing the virtual three-dimensional image at a virtual plane of the virtual three-dimensional image; and
identifying a region of interest of a resulting slice of the three-dimensional image based on a difference between a region of interest of the slice as compared to a surrounding slice surface of the slice.

12. The computer-implemented method of claim 1, wherein the analytical model comprises an adversarial component, a diffusion model, a neural network model, or a convolutional neural network model that is trained using a training dataset of synthetically-generated images of integrated circuit devices, lamellae cut faces or transmission electron microscope workflow images.

13. The computer-implemented method of claim 1, wherein the analytical model is further configured to reference a degree of originality when generating the synthetic image data, the degree of originality describing a variability relative to the sample information or relative to a dataset used to train the analytical model.

14. The computer-implemented method of claim 1, further comprising:
inputting, by the system, computer-aided drafting (CAD) data to a set of analytical models comprising the analytical model and additional analytical models different from the analytical model, that have been trained to generate endpointing instructions based on the CAD input to the set of analytical models;
generating, by the set of analytical models, endpointing instructions for a scientific imaging system comprising one or more of a focused ion beam (FIB) subsystem or a scanning electron microscope (SEM) subsystem;
generating, by the set of analytical models, additional synthetic image data comprising template information describing a sequence of integrated circuit (IC) devices;
based on the additional synthetic image data and on the set of synthetic images, generating, by the set of analytical models, metrology information comprising a region of interest (ROI) specification for use with a sample to be imaged; and
based on the metrology information, generating, by the by the set of analytical models, control instructions for the scientific imaging system comprising a transmission electron microscope (TEM) subsystem or another scientific imaging system.

15. The computer-implemented method of claim 1, further comprising:
inputting, by the system, computer-aided drafting (CAD) data to a set of analytical models comprising the analytical model and additional analytical models different from the analytical model, that have been trained to generate endpointing instructions based on the CAD input to the set of analytical models;
generating, by the set of analytical models, endpointing instructions for a scientific imaging system comprising one or more of a focused ion beam (FIB) subsystem or a scanning electron microscope (SEM) subsystem;
based on the CAD input and on the endpointing instructions, generating, by the set of analytical models, a set of synthetic images, comprising the synthetic image, of the sample as a function of depth of imaging of the sample;
based on at least one synthetic image of the set of synthetic images, generating, by the set of analytical models, additional synthetic image data comprising template information describing a sequence of integrated circuit (IC) devices;
based on the additional synthetic image data and on the set of synthetic images, generating, by the set of analytical models, metrology information comprising a region of interest (ROI) specification for use with a sample to be imaged; and
based on the metrology information, generating, by the by the set of analytical models, control instructions for the scientific imaging system comprising a transmission electron microscope (TEM) subsystem or another scientific imaging system.

16. A charged particle beam system, comprising:
a source of charged particles, a machine-actuated sample holder, and control circuitry operatively coupled to:
a memory that stores computer executable components; and
a processor that executes the computer executable components stored in the memory to cause the processor to perform operations comprising:
generating image data of a sample disposed in the sample holder;
inputting a portion of the image data to an analytical model that is trained on a dataset of synthetic image data describing synthetic images corresponding to the image data of the sample; and
generating, by the analytical model, control instructions configured to modulate an operation of the source of charged particles or the sample holder in response to being processed by the control circuity.

17. The charged particle beam system of claim 16, further comprising:
a focused ion beam (FIB) subsystem; and
a scanning electron microscope (SEM) subsystem,
wherein the sample comprises one or more complementary metal-oxide semiconductor (CMOS) devices, dynamic random-access memory (DRAM) devices, or NOT-AND (NAND) devices, and
wherein control instructions comprise endpointing instructions configured to modulate the operation of the FIB subsystem and the SEM subsystem to delayer the sample and reveal the one or more CMOS devices.

18. The charged particle beam system of claim 16, further comprising:
a transmission electron microscope (TEM) system,
wherein the sample comprises one or more complementary metal-oxide semiconductor (CMOS) devices, dynamic random-access memory (DRAM) devices, or NOT-AND (NAND) devices, and
wherein the control instructions comprise metrology information based at least in part on the image data describing the one or more CMOS devices, dynamic random-access memory (DRAM) devices, or NOT-AND (NAND) devices.

19. A computer program product facilitating a process for imaging device endpointing, the computer program product comprising a computer readable storage medium having program instructions embodied therewith, the program instructions executable by a processor to cause the processor to:
process, by the processor, sample information describing a set of original features of a sample, resulting in processed model input information; and
generate, by the processor, synthetic image data, usable to generate a synthetic image, and describing at least a portion of the set of original features and based on the processed model input information.

20. The computer program product of claim 19, wherein the synthetic image comprises a virtual three-dimensional image, and wherein the program instructions are further executable by the processor to cause the processor to:
virtually slice, by the processor, the virtual three-dimensional image at a virtual plane of the virtual three-dimensional image; and
identify, by the processor, a region of interest of a resulting slice of the three-dimensional image based on a difference between a region of interest of the slice as compared to a surrounding slice surface of the slice.
